(19) United States
(12) Patent Application Publication
(10) Pub. No.: US 2003/0066830 A1
(43) Pub. Date: Apr. 10, 2003

(54) Magnetic heater apparatus and method

(75) Inventors: TRoy Reed, Skiatook, OK (US); Tim Lunneborg, Wahpeton, ND (US); Kevin Loll, Wahpeton, ND (US); Paul Gene Dimmer, Wahpeton, ND (US); James Ronald Thomas, Battle Lake, MN (US); Neil Howard Thomas, Brookings, SD (US)

Correspondence Address: MERCHANT & GOULD PC, P.O. BOX 2903, MINNEAPOLIS, MN, 55402-0903, US

(73) Assignee: MagTec LLC, Fargo, ND

(21) Appl. No.: 10/269,690

(22) Filed: Oct. 11, 2002

Related U.S. Application Data
(63) Continuation of application No. PCT/US02/23569, filed on Jul. 23, 2002.
(60) Provisional application No. 60/307,409, filed on Jul. 24, 2001.

(51) Int. Cl. H05B 6/10

(52) U.S. Cl. 219/672; 219/628

(57) ABSTRACT

An apparatus and method for generating heat, in particular for heating a fluid. The apparatus includes a frame, with at least one permanent magnet fixedly mounted to the frame. An electrically conductive member is disposed proximate the permanent magnets. The magnetic field of the magnets upon the conductive member is made to vary cyclically. Typically either the permanent magnets, the conductive member, or both are movable with respect to one another. Relative motion of the conductive member and the magnets causes the magnetic field experienced by the conductive member to vary, which causes it to become hot. The total heat energy generated in the conductive member may exceed the total energy applied to the apparatus to produce the varying magnetic field. The apparatus may include a fluid path proximate the conductive member. Fluid in the fluid path receives heat from the conductive member. The apparatus may also include a mounting member for mounting the conductive member, a drive mechanism for moving the conductive member, and a fluid driver for driving fluid within the fluid path. The method includes the steps of either an electrically conductive member, a permanent magnet proximate the conductive member, or both so as to heat the conductive member. The method may include the step of passing a fluid through a fluid path proximate the conductive member such that the fluid absorbs heat from the conductive member.

### BACKGROUND OF THE INVENTION

The claimed invention relates to an apparatus and method for generating heat using magnets. More particularly, the claimed invention relates to an apparatus and method for generating heat using magnets, in particular permanent magnets, and transferring the heat to a working fluid.

A variety of methods and devices for heating fluids are known. Most conventional methods for heating fluids involve either combustion or resistive heating. However, neither of these approaches is entirely satisfactory.

Heating fluids by combustion has been known since antiquity. Essentially, a flame is produced, and is placed proximate the fluid to be heated. In some applications, the flame is applied directly to the fluid, for example when air is blown across a flame in a conventional gas furnace. In other applications, the flame is applied to a heat sink or heat conductor, for example when a metal tank is heated over a flame in a conventional water heater.

Many variations of this basic approach are known. However, they share several common disadvantages. First, flame is inherently dangerous. Flammable materials must be kept away from the flames in order to prevent the flame from spreading. Generally, this means any flame heating device must be made of non-flammable materials, and must be built in such a way as to prevent the entry of any flammable materials into the vicinity of the flame.

In addition, any flame source requires a steady flow of fuel. This requires fuel lines, tanks, or similar structures, which can prove inconvenient in certain applications. In addition, fuel lines and tanks may present a fire or explosion hazard.

Similarly, flames require a steady flow of oxygen. Commonly oxygen is furnished via a blower that provides a flow of air to the flame. However, for certain applications, for example heating liquids, it is difficult or inconvenient to provide a reliable source of air.

Furthermore, flames produce various combustion products, many of which present a nuisance or a hazard. Soot build-up is common in conventional flame-based heating systems, and as a result such systems require regular cleaning. More seriously, flames are notorious for producing potentially toxic gases, such as carbon monoxide. Care must be taken in the design of flame-based heating systems to avoid the production of such gases, or to vent them away from areas used by people and animals.

In addition, many combustion byproducts are environmentally destructive. This is especially true when combustion is chemically incomplete, for reasons such as poor fuel mixing, low burn temperature, etc. In such cases, a variety of environmentally hazardous compounds may be produced. Furthermore, nearly all fuels produce so-called “greenhouse gases” during combustion, most notably carbon dioxide, even when combustion is relatively “clean”. Although carbon dioxide and other greenhouse gases are not necessarily directly harmful to people in small quantities, production of such gases is generally considered a disadvantage, in that they are widely believed to contribute to global climate change.

Also, many conventional flame-based heating systems operate by generating one or more extremely high-temperature point-sources of heat. That is, the active components of the systems become extremely hot, in many cases hot enough to cause injury or damage materials not specially designed for high heat tolerance. Thus people, as well as plastics, wood, paper, etc. must be kept away from the active components of a flame-based heating system in order to avoid a risk of injury or damage.

In addition, conventional flame-based heating systems generally require numerous components such as valves, tubing, flame nozzles, etc. that are either in or near the fluid to be heated. For generally non-reactive fluids, such as air, this is of limited concern. However, if corrosive or otherwise hazardous fluids are to be heated, it is typically necessary to either design the system specifically to avoid direct contact with the fluid to be heated, or to use components and materials that are resistant to the fluid in question. For complicated parts, such as valves and nozzles, this can present manufacturing and maintenance difficulties.

Resistive heating of fluids is also well-known. Conventional systems operate by passing an electrical current through a heating element with a high electrical resistance. The current flow generates heat within the heating element, and the heat is then transferred directly or indirectly to a fluid.

Although resistive heating avoids certain difficulties inherent in flame-based systems, it also suffers from several disadvantages. Though resistive heating systems do not require either fuel or oxygen, they do require that electricity be provided to the heating elements. Like fuel lines and air fans, electrical wiring may be difficult or inconvenient for certain applications.

Similarly, many conventional resistive heating systems operate by generating one or more extremely high-temperature point-sources of heat. Typically, the operating current is passed through one or more relatively small heating elements. The elements thus become extremely hot. In many cases the heating elements are heated to the point of incandescence, and may reach several thousand degrees Fahrenheit. People, plastics, wood, paper, even some types of metal and glass must be kept away from the active components of a resistive heating system in order to avoid a risk of injury or damage.

Furthermore, such temperatures exceed the ignition temperatures of certain flammable gasses and vapors, so such substances must also be kept away from the heating elements and other active components of a resistive heating system. If the presence of combustible gasses and vapors cannot be avoided, the active components must be sealed in a gas-tight enclosure to prevent fire or explosion.

In addition, resistive heating, depending as it does on transmission of a substantial electric current, poses an inherent danger of electric shock. Arcing and sparking to and from electrically energized components is a significant risk. In addition, applications that involve potentially conductive fluids, in particular water, are of special concern with resistive heating devices. The presence of such conductive fluids in or near current paths can cause short-circuits that may damage the device or harm persons or property nearby.

Furthermore, resistive heating systems are perhaps even more susceptible to corrosive or otherwise degrading fluids than flame-based systems. This is particularly the case with the heating elements. Heating elements are typically small, and are thus especially susceptible to corrosion by virtue of a high ratio of exposed area to their total volume. Heating elements are also commonly directly exposed to or directly immersed in the fluid to be heated. Furthermore, the difficulties in making heating elements corrosion resistant are increased because heating elements must also survive extremely high temperatures, and thus the materials, structures, and construction methods that may be used are limited.

### SUMMARY OF THE INVENTION

It is the purpose of the claimed invention to overcome these difficulties, thereby providing an improved apparatus and method for generating heat.

It is more particularly the purpose of the claimed invention to provide an apparatus and method for heating a fluid that does not require fuel, oxygen, or electrical current delivered to the active heating components, and that does not pose dangers from localized high temperatures, fire, electric shock, or toxic byproducts.

The present invention relates to a magnetic heater mechanism for generating heat. It includes at least one electrically conductive member and at least one magnet disposed proximate to one another. The magnetic field exerted by the magnet upon the conductive member is made to vary cyclically. This causes the conductive member to become hot. One way of accomplishing this is to move at least one of the conductive member and the magnet cyclically relative to the other. The magnetic field exerted upon the conductive member by the magnet thus varies cyclically.

More particularly, the magnetic field at a given point on the conductive member changes, such that that point on the conductive member becomes heated. In some embodiments most or all of the conductive member will become heated in this fashion. However, it is only necessary that a single point of the conductive member be so heated.

The present invention also relates to a magnetic heater with such a magnetic heater mechanism therein. An embodiment of magnetic heater in accordance with the principles of the claimed invention includes at least one magnet and at least one electrically conductive member disposed proximate the at least one magnet, but not in direct contact therewith. In certain embodiments, the magnet may be conveniently mounted on a frame. At least one of the conductor and the magnet is cyclically movable in relation to the other.

In a preferred embodiment, the at least one magnet is a permanent magnet.

A fluid path is disposed in thermal communication with the conductive member.

The relative motions of the conductive member and the magnet may vary considerably. In certain embodiments, the conductive member and/or the magnet may rotate in relation to one another. In other embodiments, one or both of the conductive member and the magnet may oscillate with respect to one another. The type of cyclical motion is not critical.

When the conductive member and/or the magnet are cyclically moved, the magnetic field applied to the conductive member by the magnet varies cyclically at at least one point on the conductive member, which causes at least that point of the conductive member to become hot. The heating depends on the electrical conductivity of the conductive member, not the magnetic or physical properties. Thus it is not necessary that the conductive member be ferromagnetic, or that it have any particular magnetic properties. Likewise, it is not necessary that the conductive member be a particular shape or size.

Fluid flowing through the fluid path absorbs heat from the conductive member.

In certain embodiments, the amount of heat energy generated within the conductive member exceeds the total energy applied to produce the cyclically varying magnetic field.

It is noted that the physical process(es) responsible for heat generation within the claimed invention have not been definitively determined as of filing of this application. It is believed that inductive heating may be at least partially responsible. Although inductive heating is known per se, the efficiency of the claimed invention in producing heat, which may exceed 100% as normally measured, is both surprising and unknown.

In addition, a device according to the principles of the claimed invention may include a drive shaft on which to mount the conductive member or the magnet for convenient cyclical motion. It may also contain a motor or other drive mechanism for driving the shaft. It may further contain a fluid driving mechanism such as a pump or blower for forcing fluid through the fluid path so as to heat the fluid efficiently.

An apparatus in accordance with the principles of the claimed invention does not require that fuel, oxygen, or electrical power be provided directly to or used within the heater mechanism itself. The risks inherent in such provisions are thus avoided.

An apparatus in accordance with the principles of the claimed invention is not prone to electrical arcing or sparking, as there is no need to apply external electrical power directly to the conductive member or the magnet in order to generate heat.

As pointed out above, one possible source for the heat generated in the conductive member is magnetic induction. It is noted that magnetic induction involves the production and dissipation of electrical eddy currents. However, eddy currents within conductors generally present negligible risks of arcing and sparking, as they are not flowing from one component to another or across a substantial distance, but rather are moving only within a local area of the conductor itself. Furthermore, eddy currents, like other electrical currents, tend to follow the lowest resistance current path, which is typically within the conductor rather than through the surrounding environment. Thus, short circuits, arcing, and sparking are naturally inhibited. Even fluids considered to be relatively conductive, such as salt water, are normally much less conductive than typical conductive solids such as metals. Thus, sparking dangers may be avoided even if such conductive fluids are to be heated.

Likewise, an apparatus in accordance with the principles of the claimed invention does not require either a flame or a hot filament to generate heat, and does not require high voltages or currents in exposed components.

An apparatus in accordance with the principles of the claimed invention, having very few parts, may be readily constructed of materials that are resistant to extreme temperatures, corrosive environments, etc. As a result, an apparatus in accordance with the principles of the claimed invention lends itself to applications wherein such conditions are found.

An apparatus in accordance with the principles of the claimed invention furthermore does not require that any component thereof be heated to an extreme temperature in order to operate. The conductive member may be heated to a moderate temperature similar to the desired temperature of the fluid, without a loss of efficiency.

An apparatus in accordance with the principles of the claimed invention, not being subject to many of the risks associated with known flame-based heaters and resistive heaters, is particularly well suited for commercial and home applications, such as furnaces, space heaters, and water heaters. However, it will be appreciated that these applications are exemplary only, and that the claimed invention is not limited thereto.

Furthermore, an apparatus in accordance with the principles of the claimed invention does not produce waste gas, or indeed waste products of any sort, and in particular does not produce greenhouse gases or other environmentally dangerous substances. Likewise, it does not produce solid waste or particulates such as ash, soot, etc., and does not produce noxious or corrosive liquids or gases, i.e. sulfur dioxide, nitrogen oxides, sulfuric acid, etc. Therefore, its operation does not present an environmental hazard.

A method in accordance with the principles of the claimed invention includes the steps of rotating at least one conductive member proximate at least one magnet so as to heat the conductive member. A fluid may then be disposed proximate the conductive member, so as to absorb heat from the conductive member.

As noted, it is believed that magnetic induction may be at least partially responsible for the heat generated in a device in accordance with the claimed invention. It is noted that conventional inductive heating devices typically rely on electromagnets to generate magnetic fields. In a preferred embodiment of the claimed invention, permanent magnets are used instead.

However, alternate embodiments of the invention might include electromagnets. Although electromagnets have many of the same drawbacks as resistive heaters, in that they require an electrical current to be delivered directly to the heating element, and in that a device that uses electromagnets thus requires wiring and must be designed with consideration given to a risk of electrical shock, for certain embodiments it may be desirable to utilize electromagnets.

Permanent magnets are extremely simple in structure, and do not have moving parts, current paths, or other internal components. As a result, they are extremely reliable, and are physically, chemically, and thermally sturdy.

In addition, the use of permanent magnets in the claimed invention, combined with the lack of any other unavoidable need for electrical power, gas lines, waste disposal, etc. enables embodiments of the claimed invention to be utilized with little or no supporting infrastructure.

In addition, known devices utilizing magnetic inductive heating are substantially less efficient in generating heat than an apparatus in accordance with the principles of the claimed invention. For this reason, it is believed that some phenomenon other than or in addition to magnetic induction heating may be responsible for the heat generated in the claimed invention.

Thus, it is emphasized that the heating effect is not necessarily restricted to magnetic inductive heating.

### BRIEF DESCRIPTION OF THE DRAWINGS

Like reference numbers generally indicate corresponding elements in the figures.

FIG. 1 is a cross-sectional illustration of an embodiment of an apparatus in accordance with the principles of the claimed invention, adapted for rotary motion.

FIG. 2 is a perspective view of a frame with magnets therein from the apparatus illustrated in FIG. 1.

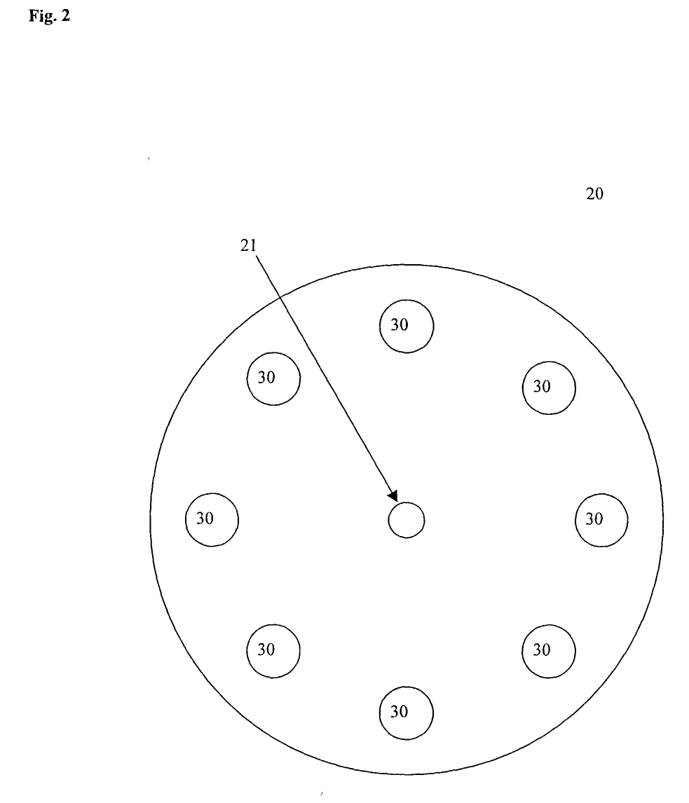

FIG. 3 is a cross-sectional illustration of another embodiment of an apparatus in accordance with the principles of the claimed invention, having multiple conductive members.

FIG. 4 is a cross-sectional illustration of another embodiment of an apparatus in accordance with the principles of the claimed invention, showing conductive and non-conductive layers.

FIG. 5 is a perspective view of an embodiment of a conductive member in accordance with the principles of the claimed invention.

FIG. 6 is a perspective view of another embodiment of a frame with magnets therein.

FIG. 7 is a perspective view of yet another embodiment of a frame with magnets therein.

FIG. 8 is a perspective view of an embodiment of a frame with magnets therein similar to that in FIG. 2, showing magnet polarities.

FIG. 9 is a cross-sectional illustration of another embodiment of an apparatus in accordance with the principles of the claimed invention, adapted for oscillatory motion.

FIG. 10 is a cross-sectional illustration of yet another embodiment of an apparatus in accordance with the principles of the claimed invention, adapted for pendulum motion.

FIG. 11 is a cross-sectional illustration of still another embodiment of an apparatus in accordance with the principles of the claimed invention, adapted for rotary motion, having an integral fluid driver.

FIG. 12 is another perspective view of an embodiment of a frame with magnets therein similar to that in FIG. 2, showing magnet polarities different from those in FIG. 8.

FIG. 13 is a perspective view of an embodiment of an apparatus in accordance with the principles of the claimed invention, wherein the spacing between the magnet and the conductive member varies.

FIG. 14 is a magnified view of a magnet similar to one from FIG. 2.

FIG. 15 is a cross-sectional illustration of an embodiment of an apparatus in accordance with the principles of the claimed invention, wherein magnets are disposed on both sides of the conductive member.

FIG. 16 is a magnified view of a portion of FIG. 15, showing exemplary magnet orientation.

FIG. 17 is a cross-sectional illustration of an embodiment of an apparatus in accordance with the principles of the claimed invention, wherein magnets are disposed on both sides of the conductive member.

FIG. 18 is a cross-sectional illustration of an embodiment of a heater in accordance with the principles of the claimed invention.

FIG. 19 is a schematic representation of a heat driven apparatus in accordance with the principles of the claimed invention.

FIG. 20 shows an embodiment similar to that of FIG. 15, with the conductive member partially withdrawn.

### DETAILED DESCRIPTION OF THE PREFERRED EMBODIMENT

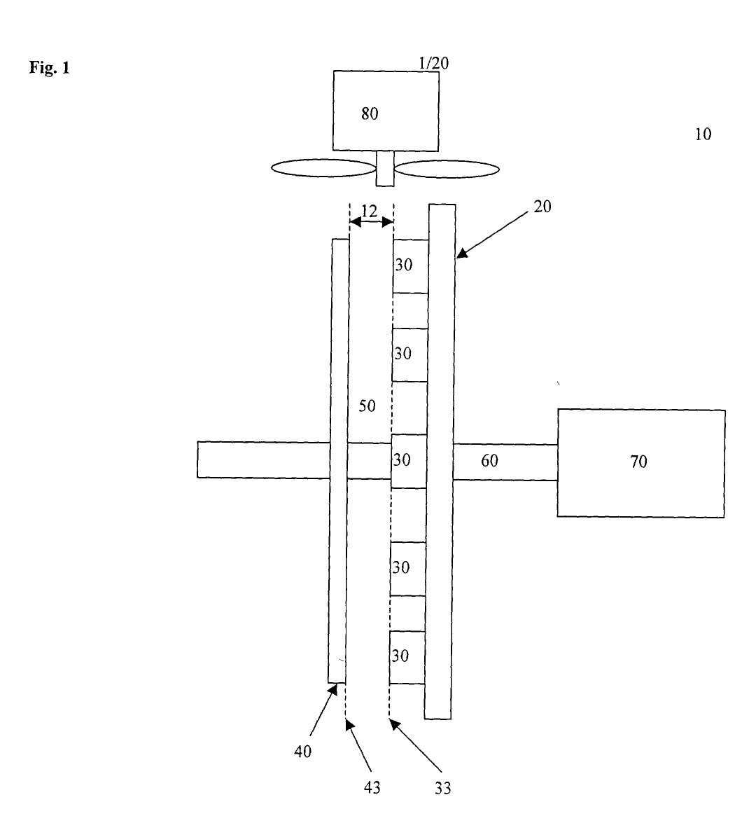

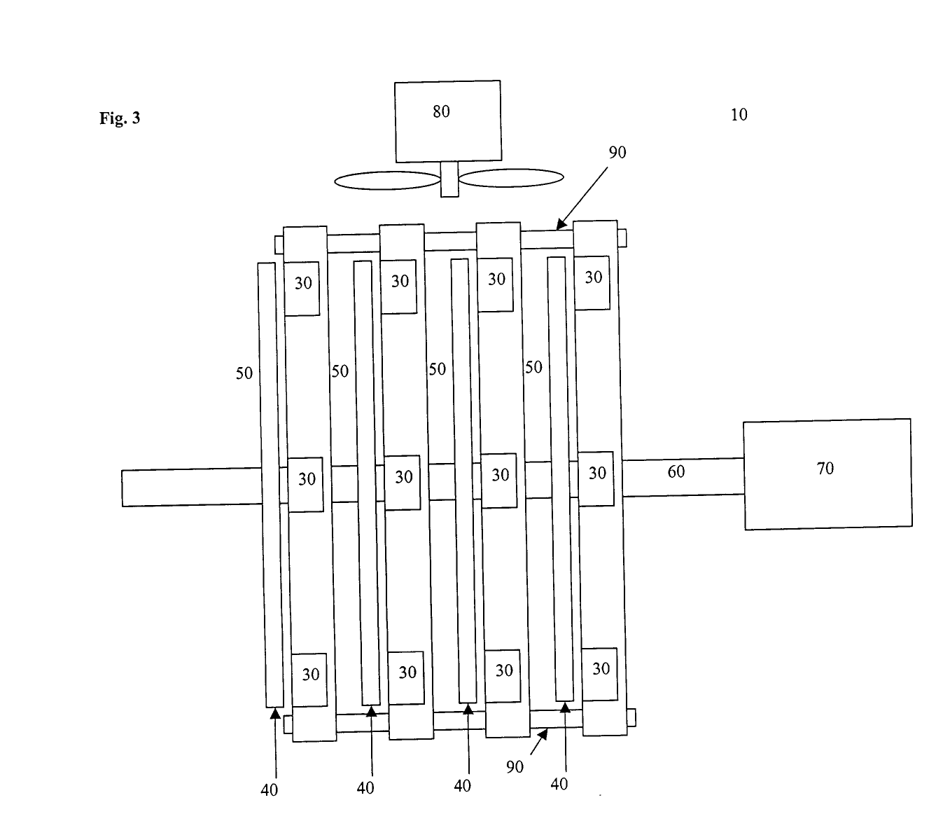

Referring to FIG. 1, an embodiment of an apparatus for magnetically generating heat 10 in accordance with the principles of the claimed invention includes a frame 20. The frame need not be electrically conductive or ferromagnetic, although it may be either or both. As illustrated in FIG. 3, the frame 20 is a circular, essentially solid plate. However, it will be appreciated by those knowledgeable in the art that this is exemplary only, and that other shapes, including but not limited to rectangles or open arrangements of struts, may be equally suitable.

In addition, the frame is itself exemplary only. It provides a convenient structure on which magnets 30 may be mounted.

Returning to FIG. 1, the apparatus includes at least one magnet 30 fixedly connected to the frame 20. As noted, in a preferred embodiment the at least one magnet 30 is a permanent magnet. A wide variety of magnets 30, permanent and otherwise, may be suitable.

In embodiments where permanent magnets are used, those embodiments are to some degree limited in their operation by the maximum effective operating temperature of the particular permanent magnets 30 that are used, i.e. if the magnets 30 overheat their magnetic field may decay. In a preferred embodiment using permanent magnets, the magnets 30 are high-temperature permanent magnets, such that they retain their magnetic fields at elevated temperatures. In a more preferred embodiment, the magnets 30 have an effective operating temperature of at least the boiling point of water. In a still more preferred embodiment, the magnets 30 have an effective operating temperature of at least 350° F.

Rare earth magnets are known to be suitable for the purposes of the claimed invention. Samarium Cobalt magnets are known to be particularly suitable for purposes of the claimed invention. However, the use of both Samarium Cobalt magnets and rare earth magnets in general is exemplary only, and other permanent magnets may be equally suitable.

The “effective operating temperature”, as the term is used in the art, is the point beyond which the magnetic field produced by a permanent magnet begins to degrade significantly. Some minor degradation in field strength may be measurable below this point. Likewise, the magnetic field may maintain at least some integrity above the effective operating temperature.

It is noted that the effective operating temperatures described herein are exemplary only. Permanent magnets with different effective operating temperatures may be equally suitable. In particular, it is noted that permanent magnets with higher effective operating temperatures may be available, or may become available, and that they may be equally suitable for use with the claimed invention.

In addition, it is emphasized that the device as a whole is not strictly limited to the operating temperatures of the magnets 30. In certain embodiments, other portions of the apparatus such as the conductive member 40 (see below) may reach higher temperatures than are experienced by the magnets 30, temperatures which may be well in excess of the maximum operating temperature of the magnets 30 themselves.

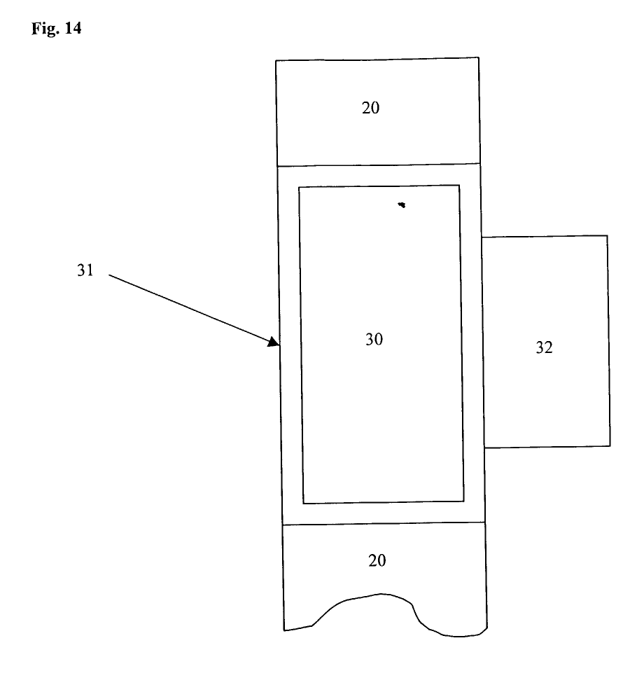

Furthermore, the magnets 30 may be protected from excess heat, as well as other potential hazards. For example, as illustrated in FIG. 14, which shows a cross-section of a magnet 30 and a portion of a frame 20 similar to that of FIG. 3 in cross-section and in greater detail, the magnet 30 may include a protective layer 31. Such a protective layer 31 can provide thermal protection, and/or structural and chemical protection. A variety of materials may be suitable for use as a protective layer 31, so long as they do not significantly reduce the propagation of the magnetic field of the magnet 30.

For certain embodiments, aluminum may be provide a suitable protective layer 31. It is noted that aluminum has a high reflectivity, thus inhibiting the absorption of heat by the magnet 30, and a high infrared emissivity, thus facilitating the rapid re-radiation of heat from the magnet 30. These factors combine to provide passive cooling for the magnet 30. In addition, aluminum is relatively durable, and so a protective layer 31 of aluminum serve to protect the magnet 30 physically. Likewise, aluminum is relatively impermeable, and thus may effectively seal the magnet 30 against any potential corrosive effects due to moisture, oxygen, fluid flowing through the fluid path 50 (see below), etc.

However, the use of aluminum is exemplary only, and a variety of other materials may be equally suitable. In particular, it is noted that multiple layers of material, rather than a single layer (i.e. of aluminum), may also be suitable. Likewise, the presence of a protective layer 31 is also exemplary only.

In addition, for certain embodiments, the apparatus may include an additional active or passive cooling mechanism 32 for the magnets 30. A wide variety of cooling mechanisms 32 may be suitable. For example, passive cooling mechanisms 32 may include, but are not limited to, heat sinks and radiator fins. Active cooling mechanisms 32 may include, but are not limited to, coolant loops and refrigeration units.

It is noted that the fluid flow path 50, as described below, may be configured to act as a cooling mechanism 32. Since in certain embodiments of the claimed invention it provides a mechanism for absorbing heat from the conductive member 40, it may be well suited for absorbing heat from the magnets 30 as well.

However, these particular cooling mechanisms 32, as well as the presence of a cooling mechanism at all, are exemplary only.

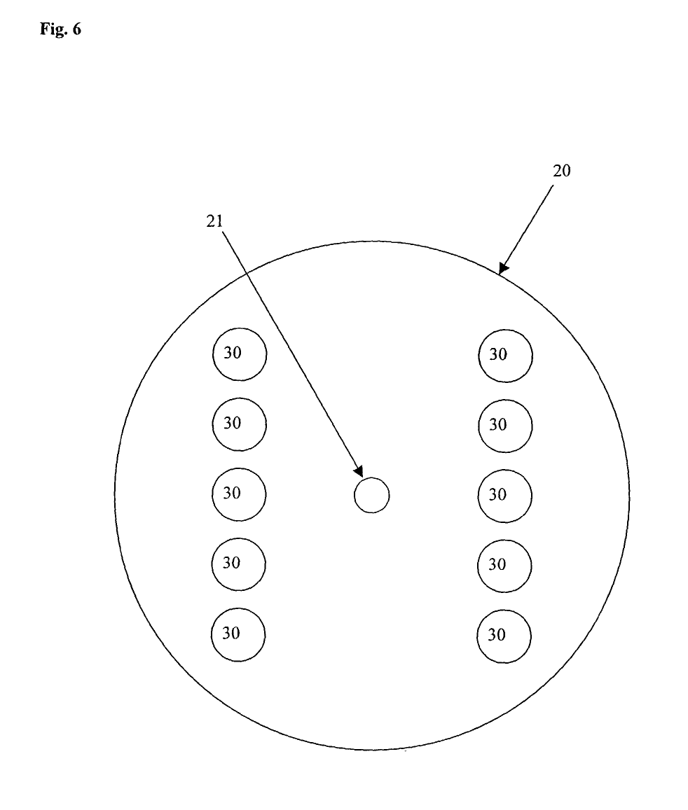

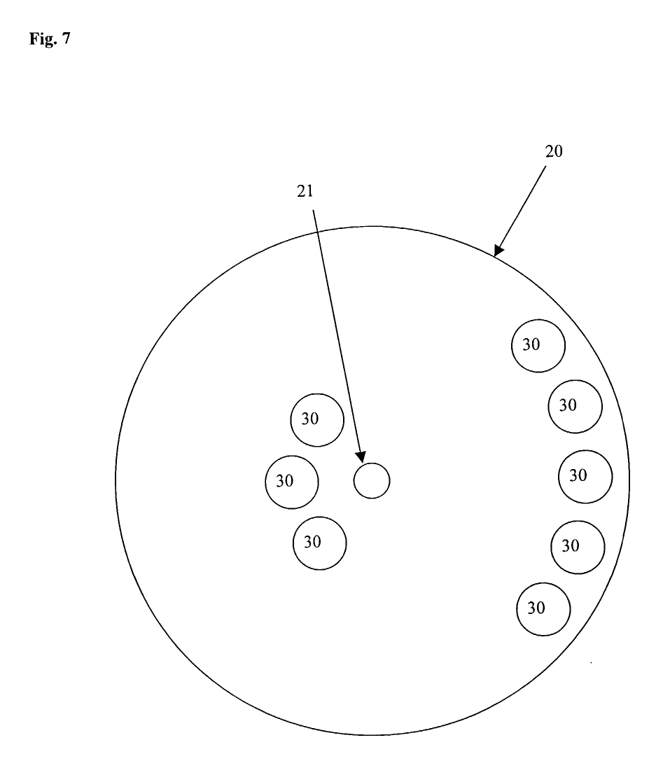

In a preferred embodiment, the apparatus includes a plurality of magnets 30. As illustrated in FIGS. 1 and 3, the apparatus has eight magnets 30, distributed symmetrically about the periphery of the frame 20. However, it will be appreciated by those knowledgeable in the art that this is exemplary only. A wide variety of sizes, shapes, numbers, and arrangements of magnets 30 may be equally suitable. In particular, asymmetrical arrangements of magnets 30 and arrangements of magnets 30 elsewhere than the periphery of the frame 20 may be suitable. For example, FIG. 6 shows an arrangement of magnets 30 in two straight rows. FIG. 7 shows an arrangement of magnets 30 with three in one arc near the center of the frame 20, and five in a larger arc near the periphery of the frame 20.

In addition, although the magnets 30 are illustrated as disk-shaped, this is exemplary only. Magnets in other shapes, including but not limited to rectangular, may be equally suitable. Furthermore, the magnets 30 need not all have the same shape.

Moreover, although an arrangement of small magnets 30 is convenient for certain applications, this is also exemplary only. Magnets 30 of sizes other than those shown may be equally suitable. Furthermore, in embodiments having more than one magnet 30, the magnets 30 need not be of the same size.

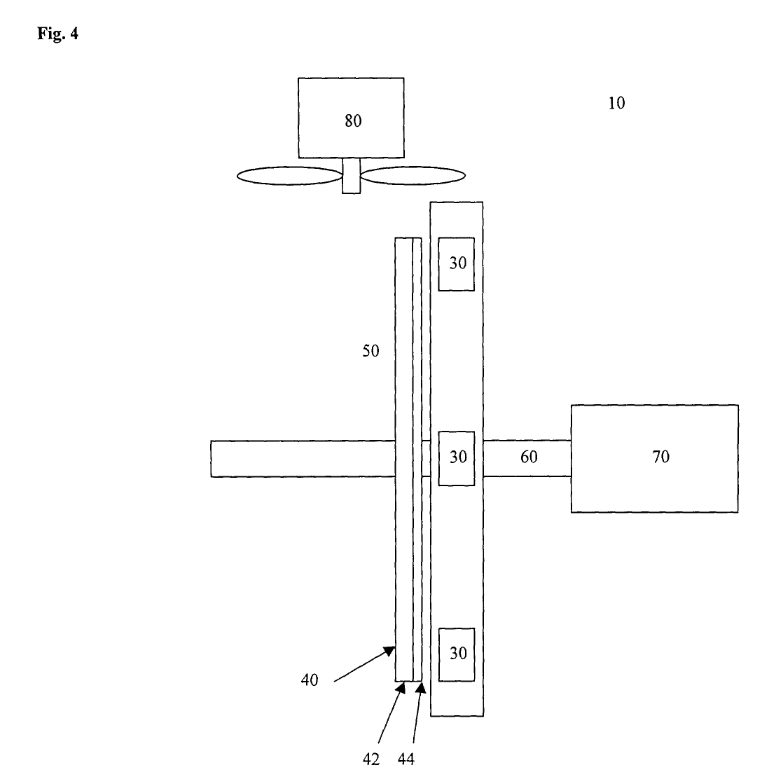

Furthermore, as illustrated in FIG. 1, the magnets 30 are fixed to a surface of the frame 20. However, this arrangement is exemplary only. As illustrated in FIG. 3, the magnets 30 may be recessed into the frame 20. The magnets 30 may be fully recessed as illustrated, such that the surfaces of the magnets 30 are flush with the surface of the frame 20, or the magnets 30 may be partially recessed into the frame 20. Alternatively, the magnets 30 may be fully enclosed within the frame 20, as illustrated in FIG. 4. A wide variety of arrangements of magnets 30 may be suitable, so long as the magnetic fields generated by the magnets 30 extend beyond the surface of the frame 20.

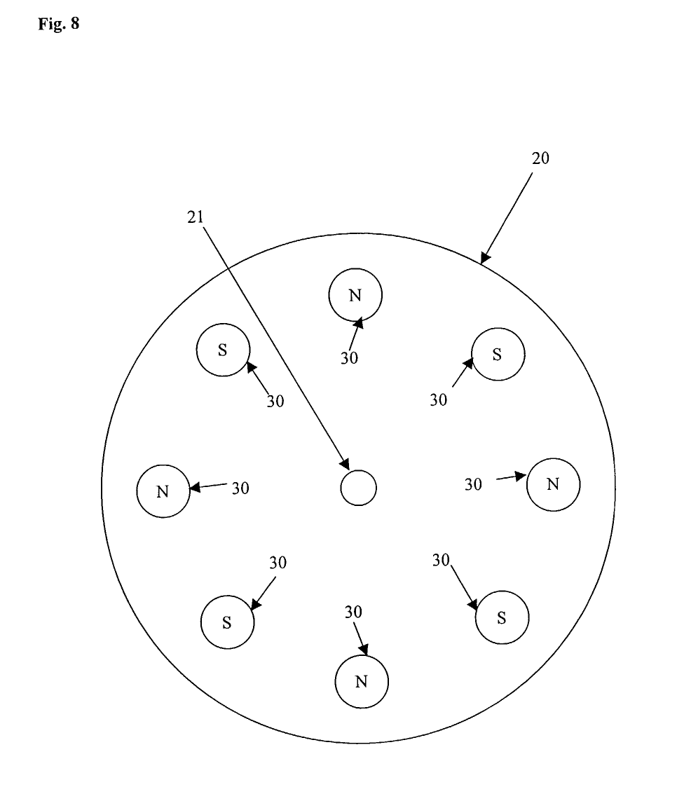

The magnets may be oriented in various manners. In a preferred embodiment, all of the magnets will be oriented with alternating polarity. That is, as shown in FIG. 8, some have their north poles N facing out of the paper, while those on either side have their south poles S facing out of the paper (and their north poles N facing into the paper). Such an arrangement is advantageous, for at least the reason that it produces a greater change in magnetic field intensity than would be the case if all of the magnets 30 were aligned in the same direction.

It is noted that such an arrangement may be equivalently described as having the north pole N of some of the magnets 30 point directly towards the conductive member 40, while having the north pole N of alternating magnets 30 point directly away from the conductive member 40.

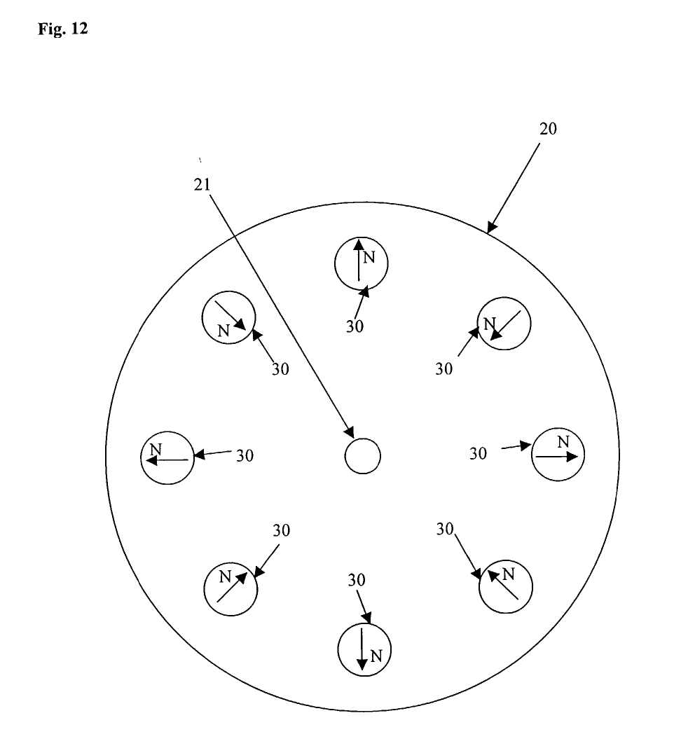

However, such an arrangement is exemplary only. Other arrangements may be equally suitable. For example, it would also be possible to arrange the magnets 30 with alternating polarity such that the north pole of each magnet 30 is arranged opposite or nearly opposite that of its neighbors. FIG. 12 shows an example of such an arrangement. As shown therein, some of the magnets 30 have their north poles N pointing inward towards the center of the frame 20, while the magnets 30 on each side of them have their north poles N pointing outward.

Furthermore, it may also be advantageous to arrange magnets 30 with their north poles aligned in the same or nearly the same direction, or in some fashion other than the alternating fashions described above. In particular, it is emphasized that the alignment of the poles of the magnets 30 is not limited to either directly parallel with or directly perpendicular to the plane (if any) of the frame 20. The magnets 30 may be oriented in essentially any fashion, so long as a varying magnetic field results.

At least one electrically conductive member 40 is disposed proximate the magnets 30.

The magnets 30 and the conductive member 40 are arranged so that at least a portion of the conductive member 40 experiences a cyclically varying magnetic field from the magnets 30.

One way of producing the cyclically varying magnetic field is for at least one of the electrically conductive member 40 and the permanent magnets 30 are to be cyclically movable with respect to the other. Thus, as either the magnets 30 or the conductive member 40 or both move, the magnetic field experienced at different parts of the conductive member 40 will vary.

A variety of motions may be possible, so long as a cyclical variation in the magnetic field experienced by the conductive member 40 is produced.

As one suitable form of motion, the magnets 30 may be rotated with respect to the conductive member 40. Alternatively, the conductive member 40 may be rotated with respect to the magnets 30. Additionally, both the magnets 30 and the conductive member 40 may be rotated in different directions, or at least at different speeds, so as to produce relative motion between the two.

In the embodiment illustrated in FIG. 1, the magnets 30 are mounted to the frame 20 in a generally planar arrangement. Likewise in the embodiment illustrated in FIG. 1, the conductive member 40 is planar. The frame 20 is disposed with the plane 33 of the magnets 30 generally parallel to and proximate the plane 43 of the conductive member 40. Such an arrangement is advantageous, in that it is compact and convenient to operate, and also in that it allows for rapid, regular cyclical motion by rotating the frame 20 or the conductive member 40. However, it is exemplary only. Other arrangements, including but not limited to those described below, may be equally suitable.

It is noted that FIG. 1, as illustrated, is inclusive of all of the above embodiments. That is, as illustrated, the frame 20 with the magnets 30 thereon may rotate, or the conductive member 40 may rotate, or both. The structure, appearance, and function of the apparatus will be similar regardless of which elements rotate.

As noted above, other cyclical motions and other arrangements of components may be equally suitable.

For example, oscillating motions may be suitable.

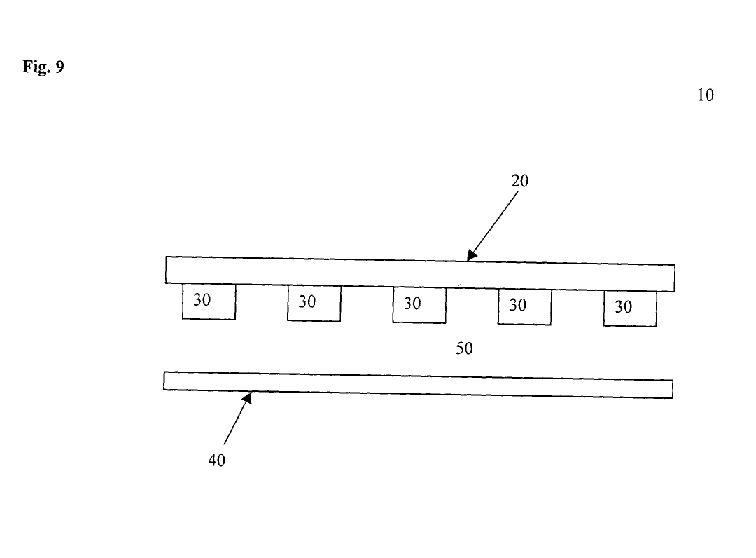

More particularly, linear oscillating motions may be suitable for certain embodiments. As illustrated in FIG. 9, a planar frame 20 with magnets 30 thereon may be placed proximate a planar conductive member 40. Either or both of the frame 20 and the conductive member 40 may be moved cyclically in a non-rotational direction, i.e. side-to-side. Alternatively, one or both of the frame 20 and the conductive member 40 may be moved towards and away from each other.

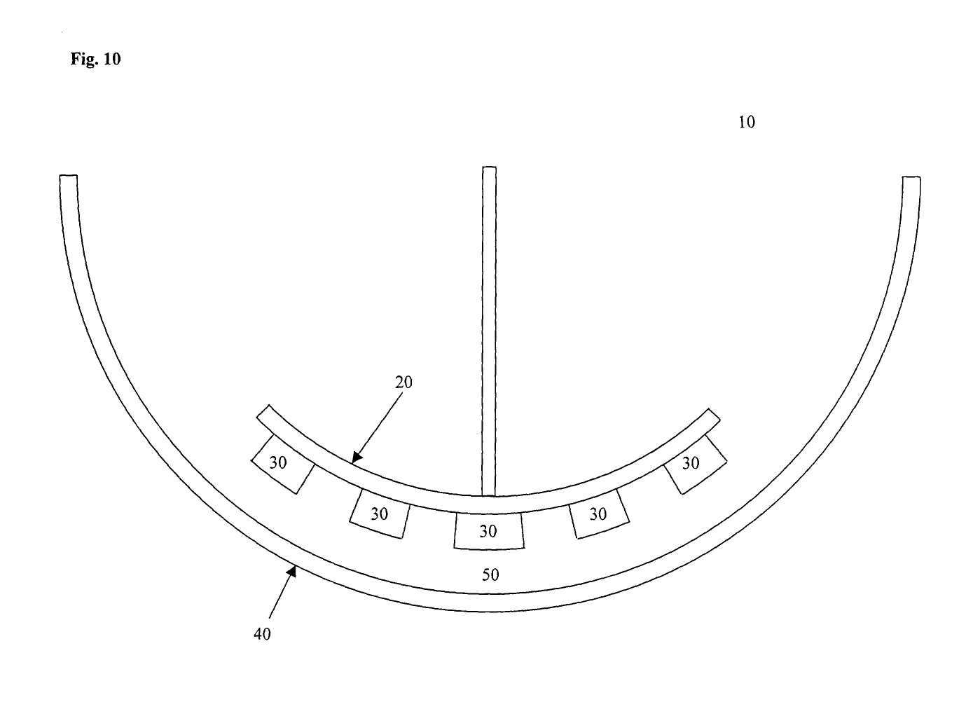

Alternatively, in some embodiments the oscillating motion of a pendulum may be equally suitable. As illustrated in FIG. 10, a curved frame 20 with magnets 30 thereon may be placed proximate a conductive member 40 having a matching curve. The frame 20 may be set into motion as a pendulum, so as to produce cyclical variations in the magnetic field experienced by the conductive member 40.

A wide variety of other arrangements and motions may also be suitable, including but not limited to a cylinder or torus rotating inside a larger torus, a cylinder rotating proximate a flat plate, or a piston moving back and forth within a cylinder. In each case, either the magnets 30, the conductive member 40, or both may move.

It is noted that the term “cyclical variation”, as used herein with regard to magnetic fields, refers broadly to any generally repetitive motion, wherein the magnetic field changes according to some cycle. For example, the magnetic field may rise and fall in intensity. As another example, the rise and fall of the magnetic field may change in field direction, i.e. change the angle of magnetic north, or even completely reverse polarity from north to south. Furthermore, the variations in the magnetic field may include a combination of changes in both field direction and intensity. The pattern of repetition may be simple or complex, and need not be precisely repeated with each cycle. That is, the frequency, amplitude, etc. of the variation may change from cycle to cycle. In addition, in embodiments wherein both the intensity and the direction of the field changes, it is not necessary for the intensity and the direction to change synchronously, or according to the same cycle.

The term “cyclical variation” as used herein with regard to physical motion, by extension, refers broadly to the physical motion used to produced the cyclical variation of the magnetic field. Likewise, it may have a pattern of repetition that is simple or complex, and that varies from cycle to cycle

It is also noted that the total magnetic force or field strength on the conductive member 40 need not change (although it may in certain embodiments). Rather, the local field at a given point on the conductive member 40 must change, in order for that point to be actively heated.

For example, if, in the embodiment illustrated in FIG. 1, the frame 20 rotates, the magnets do not approach or recede from the conductive member 40, since they are moving about an axis perpendicular to the plane 33 of the magnets 30 and the plane 43 of the conductive member 40. Thus, the total field strength does not change. However, the field at any given point on the conductive member 40 is constantly changing as the frame 20 rotates, i.e. as individual magnets approach and recede from that point.

Furthermore, it is emphasized that although many of the embodiments described herein utilize physical motion to produce a cyclically varying magnetic field, this is exemplary only. Arrangements for producing a cyclically varying magnetic field without physical motion, including but not limited to the use of variable electromagnets, may be equally suitable.

The cyclical change in the magnetic field causes the conductive member 40 to become hot. In terms of physical motions, with regard to FIG. 1, when the conductive member 40 is rotated with respect to the magnets 30, (or vice versa) the conductive member 40 becomes hot, because the magnetic field experienced by the conductive member 40 is varying.

It is emphasized that the conductive member 40 is electrically conductive; although it is heated by interacting with magnets 30, the conductive member 40 is not required to be ferromagnetic, or to have any other particular magnetic properties. Although it may be ferromagnetic, it is the electrical properties of the conductive member 40, not any magnetic properties, that are important.

In a preferred embodiment, the conductive member 40 is made of a durable, heat-tolerant, highly conductive material. In a more preferred embodiment, the conductive member 40 is made of metal. In a still more preferred embodiment, the conductive member 40 is made of copper, or a copper alloy. This is advantageous, as copper and many of its alloys are physically durable, highly conductive, and resistant to high temperatures. However, this is exemplary only, and other materials may be equally suitable for use in the conductive member 40.

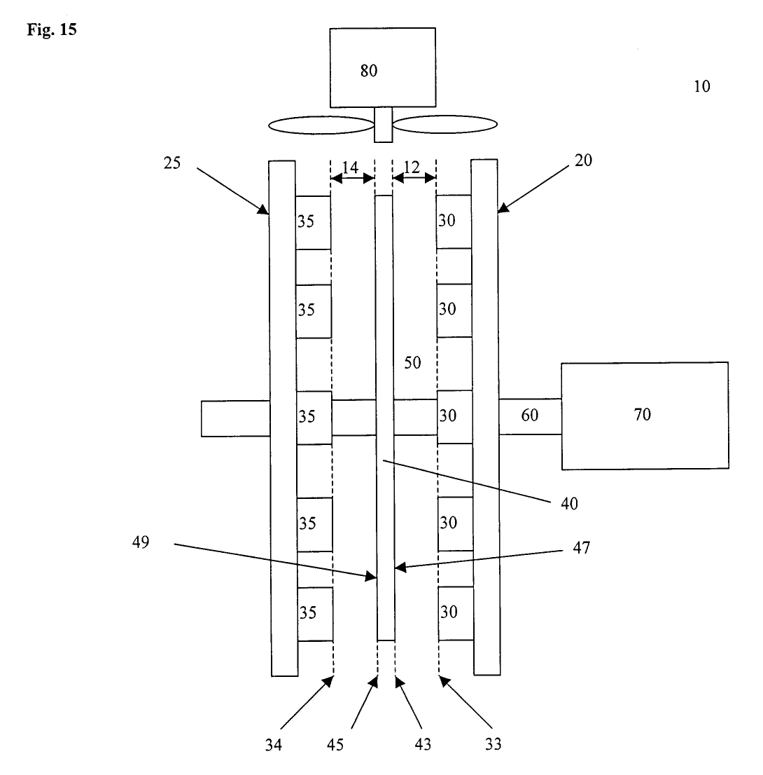

As noted, a wide variety of embodiments may be possible in accordance with the principles of the claimed invention. However, from the point of view of operating efficiency (about which more is said later), the preferred embodiment is that illustrated in FIG. 15.

Therein, the conductive member 40 is configured with a first side 43 and a second side 45. A first frame 20 with a plurality of first magnets 30 thereon is disposed a first distance 12 away from the first side 43 of the conductive member 40. Similarly, a second frame 25 with a plurality of second magnets 35 thereon is disposed a second distance 14 away from the second side 45 of the conductive member 40.

It is preferred that the frames 20 and 25 are arranged such that the magnets 30 and 35 are aligned with one another to form pairs on each side of the conductive member 40. Likewise, it is preferred that, for embodiments wherein the frames 20 and 25 are movable, they are movable together so as to maintain the arrangement and keep the magnets 30 and 35 in pairs.

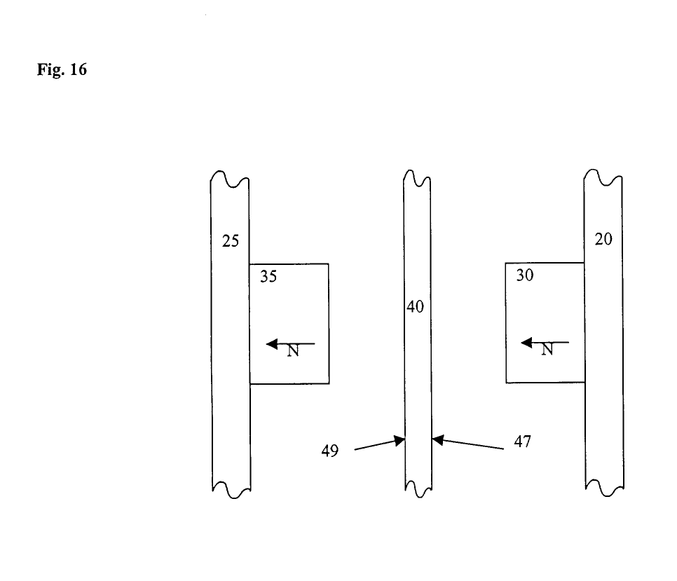

As shown in FIG. 16, it is furthermore preferred that for any pair of magnets 30 and 35, their polarities face in the same direction. Most preferably, the magnets 30 and 35 are aligned such that one magnet in the pair has its north pole facing directly towards the conductive member 40, and one magnet in the pair has its north pole facing directly away from the conductive member 40.

Such an arrangement has been found to produce a high level of heating. It is believed that this is due to the steep gradient in the magnetic field that is produced when the conductive member 40 is disposed between two magnets 30 and 35 oriented in this fashion.

As shown in FIG. 16, both magnets 30 and 35 have their north poles pointing directly to the left. However, it would be equally suitable, and in accordance with this most preferred arrangement, for both magnets 30 and 35 to have their north poles pointing directly to the right.

Furthermore, as noted above, it may be suitable for adjacent magnets to have opposing polarities. That is, if one pair of magnets 30 and 35 have their poles arranged as shown in FIG. 16 (north to the left), the magnet pairs adjacent to that pair may have their poles arranged in the direction opposite that shown in FIG. 16 (north to the right).

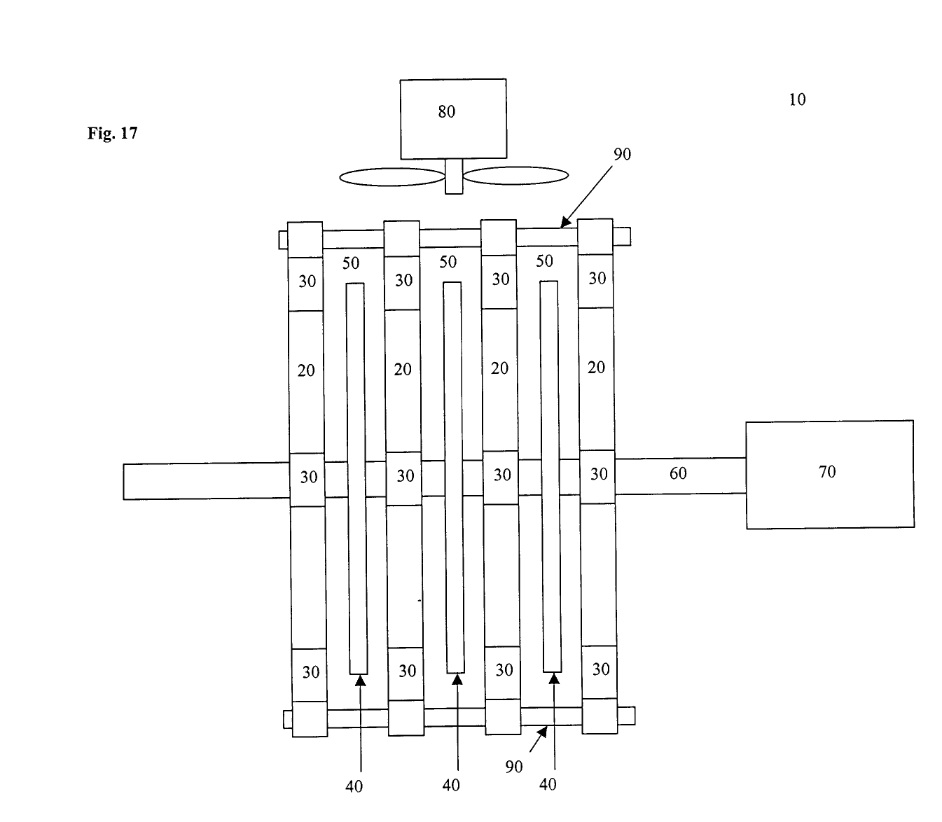

As with the embodiment shown in FIG. 1, the embodiment of FIG. 15 may be conveniently expanded by the use of additional conductive members 40 and magnets 30. An arrangement with three conductive members 40 and four sets of magnets 30 is shown in FIG. 17. It is noted that the number of conductive members 40 and magnets 30 is exemplary only, and that other numbers and arrangements may be equally suitable.

In addition, it is noted that this preferred arrangement is exemplary only, and that other arrangements may be equally suitable.

The heat generated varies inversely with the distance 12 between the conductive member 40 and the magnets 30. Thus, in a preferred embodiment of an apparatus in accordance with the principles of the claimed invention, the conductive member 40 is spaced a distance 12 of no more than 0.35 inches from the magnets 30. In a more preferred embodiment, the conductive member 40 is a distance 12 of no more than 0.060″. However, this arrangement is exemplary only.

In addition, although in certain embodiments the distance between the magnets 30 and the conductive member 40 may be fixed, this is exemplary only. It may be equally suitable to vary the distance between the magnets 30 and the conductive member 40, either during the operation of the apparatus or as an adjustment while the apparatus is not operating.

In particular, it is noted that it is possible to vary the magnetic field at the conductive member by varying the distance between the magnets 30 and the conductive member 40. A wide variety of embodiments may be suitable for doing so. For example, referring to FIG. 1, varying the distance 12, i.e. by moving the conductive member 40 or the frame 20 with the magnets 30 thereon from side to side, would change the magnetic field experienced by the conductive member 40. If the distance 12 were varied cyclically, this would generate heat in the conductive member 40 regardless of whether the conductive member 40 or the magnets 30 were rotated.

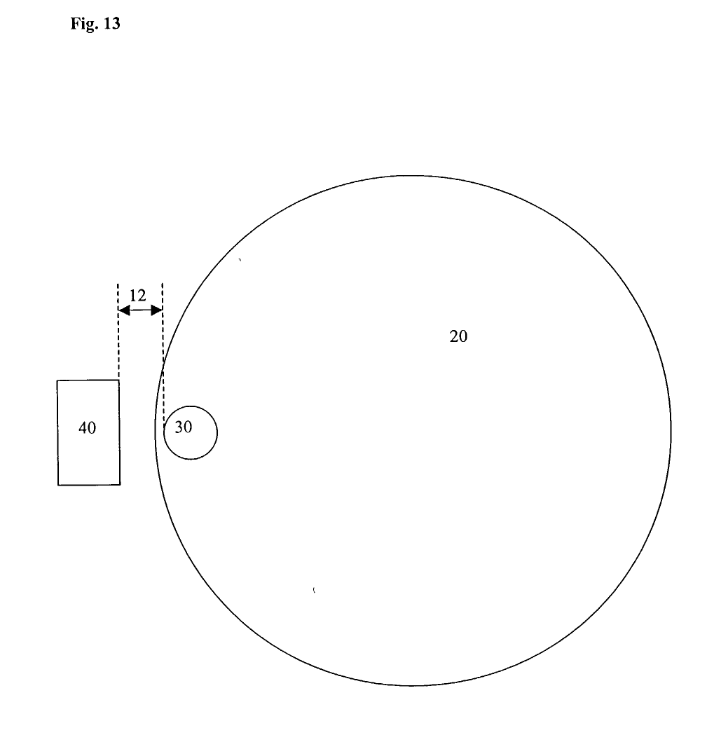

Another embodiment taking advantage of this feature is illustrated in FIG. 13. Therein, the single magnet 30 and the conductive member 40 are arranged such that when the frame 20 rotates, the distance 12 varies cyclically as the magnet 30 approaches and recedes from the conductive member 40.

It is furthermore noted that the variation in distance, whether during operation or not, may be accomplished by moving either the magnets 30, the conductive member 40, or both.

Alternatively, rather than adjusting the distance between the magnets 30 and the conductive member 40, for certain embodiments it may be advantageous to move the magnets 30 and/or the conductive member 40 in and out of the apparatus 10.

For example, referring to FIG. 15, either or both of the frames 20 and 25 and/or the conductive member 40 could be slid into or out of the apparatus 10 as a whole. That is, rather than (for example) moving the frames 20 and 25 apart so as to widen the distances 12 and 14, the frames 20 and 25 could be moved downwards, so as to partially or fully remove one or both from the apparatus 10.

If both frames 20 and 25 are fully removed, the heat generation in the apparatus 10 is essentially zero, as the conductive member 40 are not exposed to a cyclically varying magnetic field. If only one is removed, or if one or both are partially removed, the heat generation of the apparatus 10 at a given speed of operation would decrease, but not to zero.

Thus, this provides an additional way to control heat production. Such motions may be considered structurally analogous to the insertion and removal of fuel rods in a nuclear reactor.

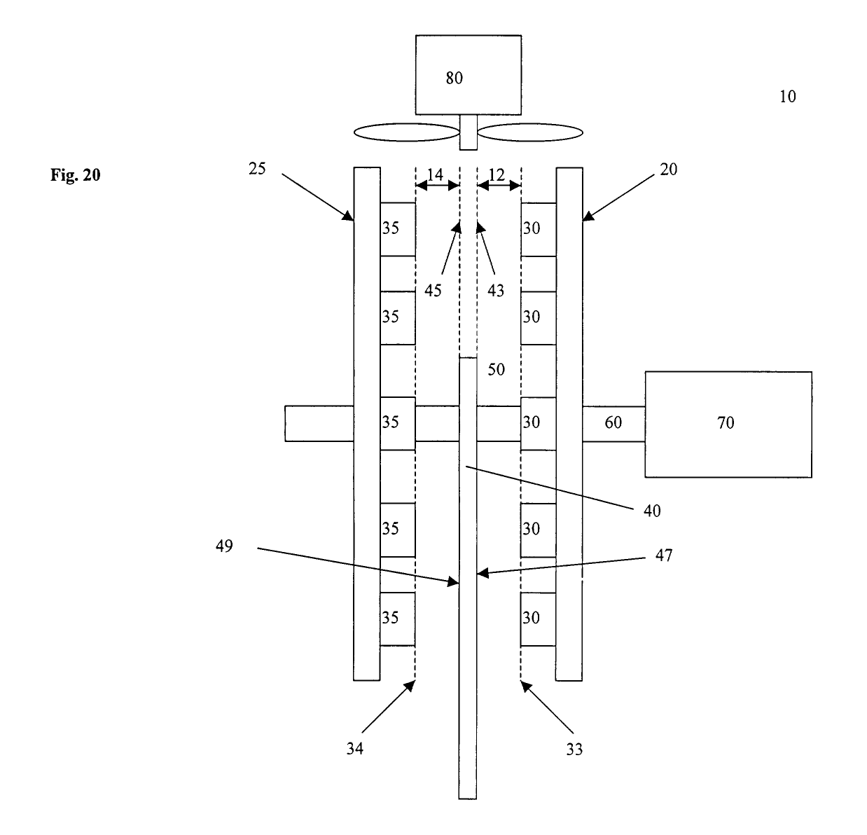

Such an arrangement is shown in FIG. 20, with the conductive member 40 partially withdrawn from the apparatus 10.

As with the variations of the distances 12 and 14, depending on the embodiment it may be advantageous for the frames 20 and 25 to be removable while the apparatus 10 is not operating, while it is operating, or both.

As noted above, in certain embodiments, the magnets 30 may be disposed in a planar arrangement, such that a surface of the magnets 30 defines a plane 33. Likewise, the conductive member 40 may have a planar shape, so as to generally conform to a plane 43. This is a convenient arrangement for certain embodiments, in that it allows for rapid motion (and hence rapid variation in the magnetic field) without any relative translation between the conductive member 40 and the magnets 30. Thus, the conductive member 40 and the magnets 30 may be disposed very close to one another without risking a collision.

However, as also noted previously, such an arrangement is exemplary only. It is not necessary for the magnets 30 to be arranged in a plane 33, or (as noted above) for the distance 12 between the magnets 30 and the conductive member 40 to be the same for all magnets 30.

As heat is produced entirely by means of physical motion, no source of electrical power, fuel, or oxygen is necessary.

The description herein is primarily directed towards rotary motion about an axis. This is convenient, in that rotary motion about an axis may be easily and reliably produced by a variety of means. In particular, rotary motion about an axis may be produced by a variety of means that require only minimal equipment and infrastructure are suitable, including but not limited to windmills and water wheels. Likewise, internal combustion engines, human or animal power, wave action, gravity, connection with the rolling wheel of a vehicle, and other sources of motive power may be equally suitable. Additionally, rotary motion about an axis may also be produced using an electric motor, such as a conventional AC or DC motor, or by other artificial means.

In the case of an electric motor, it is noted that it is possible to operate the claimed invention therewith by powering the electric motor from a local source, such as a solar cell, battery, or other short-range or self-contained source, rather than by a connection to a large power grid. In embodiments with electromagnets, the electromagnets similarly may be powered without relying on a central electric grid. Thus, the invention may be made portable, and used without substantial supporting infrastructure. For example, embodiments may be constructed without electrical lines.

Likewise, gas lines, exhaust lines, waste disposal provisions, etc. may be dispensed with.

As a result, embodiments of the invention may be of use even when connection with a standard electrical grid, gas distribution system, etc. is inconvenient or impossible (i.e., in places where no such infrastructure is available such as remote wilderness sites and undeveloped areas).

However, it is again emphasized that other forms of motion other than rotary motion about an axis, including but not limited to linear oscillation and pendular motion, may be equally suitable.

One possible physical phenomenon that may be at least partially responsible for heating the conductive member is magnetic induction. Although magnetic induction is a known phenomenon, a brief explanation as it may apply to the claimed invention may be enlightening. In the following discussion, it is assumed for the sake of clarity that magnetic induction is responsible for heating the claimed invention. However, it is noted that magnetic induction may not be the sole source of heating, or even a source of heating, in the claimed invention.

In addition, for the sake of clarity, the following is written specifically with respect to a single embodiment as shown in FIG. 1, wherein the conductive member rotates, and the magnets are fixed in place. However, it is noted that this explanation, in so far as it may be applicable at all, is generally applicable to any embodiment of the claimed invention.

It is well known that varying magnetic fields generate electrical currents. Even if the magnets 30 generate a magnetic field that is essentially constant in strength and polarity, as is the case with permanent magnets as well as with fixed-strength electromagnets, as the conductive member 40 rotates, different portions of the conductive member 40 approach and recede from the permanent magnets 30. Thus, for any arbitrary point of the conductive member 40, the magnetic field experienced at that point varies, even if the magnetic fields produced by the permanent magnets 30 remain constant.

Such a variation in magnetic field exerted at a given point of the conductive member 40 could also be obtained by the use of variable-strength magnets. For example, it is known to vary the strength of the field emitted by an electromagnet by changing the amount of current applied to the electromagnet. Likewise, the polarity of an electromagnet may be changed by reversing the direction of the current applied thereto. Such variations may also be suitable for producing a cyclically varying magnetic field at the conductive member 40, with or without any actual physical motion.

The variation in magnetic field strength at each point of the conductive member 40 generates localized eddy currents within the conductive member 40. The eddy currents, like other types of electrical current, dissipate energy in the form of heat as they flow within the conductive member 40, due to the electrical resistance of the conductive member 40. Thus, as the conductive member 40 rotates in proximity to the permanent magnets 30, the conductive member is heated.

Alternatively, some or all of the heating of the conductive member 40 may be produced by the generation of vibrations in the molecular structure of the conductive member 40 due to the varying magnetic field strength at each point, which in turn causes internal stresses and/or friction between molecules.

As a further alternative, stresses and/or variations in the crystal structure of the conductive member 40 may be produced by the varying magnetic field.

Although the forgoing description identifies physical phenomena that may be involved in the production of heat in the claimed invention, an apparatus in accordance with the principles of the claimed invention is not limited to the production of heat via those phenomena. Additional and/or alternative phenomena may be involved.

In a preferred embodiment of a device according to the principles of the claimed invention, the conductive member 40 is disk-shaped. This is convenient, in that a disk-shape lends itself to uniform rotation and heating. However, this shape is exemplary only, and a wide variety of other shapes may be equally suitable, including but not limited to square or rectangular plates, curved components, cylinders, toroids, etc.

Also, in a preferred embodiment of a device according to the principles of the claimed invention, the conductive member 40 is a single, integral piece of conductive material. However, this configuration is exemplary only. A wide variety of other configurations may be equally suitable.

For example, the conductive member 40 need not consist entirely of electrically conductive material, so long as at least a portion of it is electrically conductive. As illustrated in FIG. 4, the conductive member 40 may consist of multiple layers, with at least one electrically conductive layer 42 and at least one non-conductive layer 44. In such a case, each electrically conductive layer 42 is heated independently.

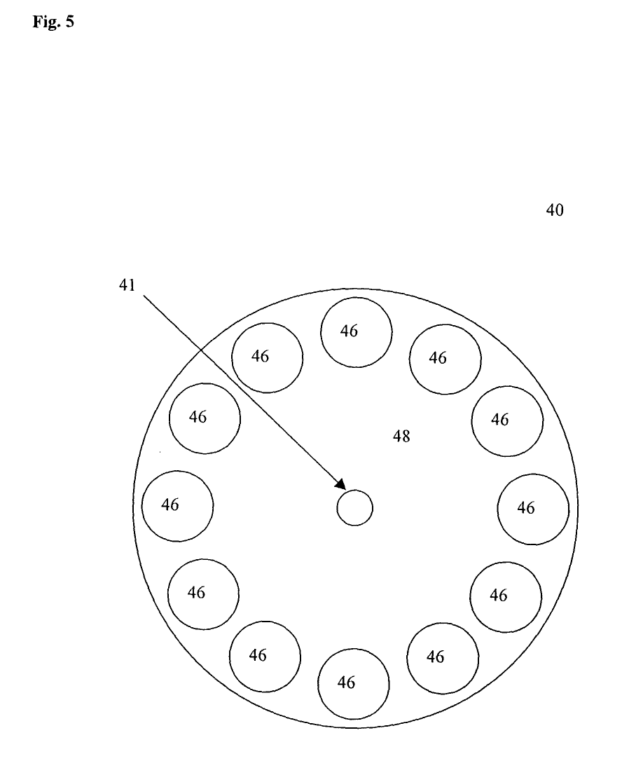

Furthermore, the conductive member 40 need not consist of a closed loop or integral piece of conductive material. As illustrated in FIG. 5, the conductive member 40 may consist of two or more separate conductors 46 that are separated from one another by non-conductive material 48. In such a case, each conductor 46 is heated independently.

Likewise, the conductive member 40, even if a single contiguous piece of conductive material, might be shaped with apertures, or be constructed of wires, beams, rods, etc. with empty space therebetween.

The rate of heat generation depends on the magnitude of the variation in magnetic field experienced by the conductive member 40. This in turn depends on the placement and field strength of the magnets, on the speed of relative motion between the conductive member 40 and the permanent magnets 30, the placement of the conductive member 40 with respect to the permanent magnets 30, and on the shape, size, and electrical conductivity of the conductive member 40.

Likewise, the rate of heat generation currents depends on the shape, size, and electrical conductivity of the conductive member 40.

Therefore, for a given embodiment, the heat generated may be controlled by varying the speed of relative motion between the conductive member 40 and the magnets 30. Thus, the heat generated by an apparatus in accordance with the principles of the claimed invention may be controlled with a high degree of precision. Because of the forgoing, the apparatus may be made to operate at essentially any speed, so as to produce a wide range of heat outputs. The apparatus is thus continuously variable in heat output, up to the maximum temperature limits of the materials used in its construction.

In a preferred application of an apparatus in accordance with the principles of the claimed invention, the speed of motion may be set such that the temperature of the conductive member 40 does not exceed 120° F., so as to enable generation of heat without posing a burn hazard to persons nearby.

In an alternative preferred embodiment of an apparatus in accordance with the principles of the claimed invention, the relative motion between the conductive member 40 and the magnets 30 may be set to a speed such that the conductive member 40 is heated to at least the boiling point of water, so as to enable generation of steam.

In yet another preferred embodiment of an apparatus in accordance with the principles of the claimed invention, the relative motion between the conductive member 40 and the magnets 30 may be set to a speed such that the conductive member 40 is heated to at least 350° F., so as to enable convenient cooking or the release of large quantities of heat in a short time.

It will be appreciated by those knowledgeable in the art that the precise speed of motion that is necessary to achieve the aforementioned temperatures depends on the geometry of the particular embodiment. For example, for rotary motion, speeds of less than 1 rpm or of greater than 5000 rpm may be suitable for particular applications. Motions other than rotary likewise may vary substantially. Furthermore, a variable speed may be equally suitable, so as to generate variable temperatures and variable quantities of heat.

A preferred embodiment of an apparatus in accordance with the principles of the claimed invention also includes at least one fluid path 50 proximate the conductive member 40. When the conductive member 40 is heated, fluid in the fluid path 50 receives heat from conductive member 40. Heat transfer from the conductive member 40 to fluid in the fluid path 50 may occur via one or more of conduction, convection, and radiation.

However, although the presence of a fluid flow path 50 may be advantageous for certain applications, a fluid flow path and fluid flowing therein are exemplary only. In other preferred embodiments of an apparatus in accordance with the principles of the claimed invention, heat may be generated for use via direct conduction, or by radiation from the conductive member. For example, heat could be transferred from the conductive member 40 to a solid heat conductor, heat sink, or heat storage device, i.e. a mass of ceramic, brick, stone, etc.

It is noted that the term “fluid” is used herein in a broad mechanical sense, so as to mean essentially any substance that may be made to flow. Thus, fluids may include, but are not limited to, sand, sugar, or other granular solids; regular dimensional solids such as beads, beans, or pellets; or irregular dimensional solids such as metal filings or crushed stone. Likewise, materials that are essentially solid but that are also sufficiently deformable so as to flow may also suitable. Such materials include but are not limited to paraffin, metallic sodium, certain plastics, etc. Fluids suitable for use with the claimed invention are therefore not limited to liquids or gases, although liquids and gases are not excluded from or inappropriate for use with the claimed invention. Furthermore, suitable fluids may likewise comprise mixtures of different physical or chemical compounds, such as pellets in a suspension of liquid, solids wholly or partially dissolved in solvents, and emolliated mixtures of incompatible fluids such as oil and water.

As illustrated in FIGS. 1, 3, and 4, the fluid path 50 is an open path that brings fluid into direct contact with the conductive member 40. This is advantageous, in that it is simple to construct. However, this configuration is exemplary only, and a wide variety of other fluid paths 50, including but not limited to enclosed ducts, pipes, and reservoirs may be equally suitable.

In particular, it is noted that the fluid flow path 50 may be disposed partially or completely within other elements of the apparatus. For example, the conductive member 40 may be formed so that the fluid flow path 50 passes therethrough. As a more concrete example, the conductive member 40 might include one or more pipes or tubes made of conductive material. The pipes could be adapted to accept the flow of fluid therethrough, so as to form the fluid flow path 50 within the conductive member 40 itself. Fluid flowing through the fluid flow path 50, which in this exemplary embodiment is actually a part of the conductive member 40, would then absorb heat as it passed through the conductive member 40.

The apparatus may include a support member 60, with one or both of the conductive member 40 and the frame 20 with the magnets 30 thereon engaged therewith. As illustrated, the support member 60 is a shaft mounted such that the conductive member 40 or the frame 20 may rotate therewith. This provides a simple and mechanically durable mechanism for rotating the conductive member 40 or the magnets 30. However, this mechanism is exemplary only, and a variety of other support members 60 may be equally suitable for rotatably mounting the conductive member 40. Suitable support members 60 include, but are not limited to, bushings, bearings, belts, chains, and gears.

As illustrated, the support member 60 extends through an opening 41 in the conductive member 40. Similarly, as illustrated, the support member 60 extends through an opening 21 in the frame 20.

In a configuration adapted to rotate the conductive member 40, the opening 41 is configured to secure the conductive member 40 to the support member 60 so as to rotate therewith, while the opening 21 in the frame 20 is configured so that the support member 60 freely rotates therein. Conversely, the opening 41 may be configured so that the support member 60 rotates freely therein and the opening 21 may be configured so that the frame 20 moves with the support member 60, so that the magnets 30 may be rotated while the conductive member 40 remains fixed.

Such an arrangement is convenient for rotary motion. However, this arrangement is exemplary only, and a variety of alternative arrangements may be equally suitable, both for rotary and for non-rotary motion.

The apparatus may include a drive mechanism 70 engaged with either the conductive member 40, the magnets 30 (i.e., via the frame 20), or both. As illustrated, the drive mechanism 70 is engaged with the support member 60 such that the drive mechanism 70 drives the support member 60, which as described above may be used to drive either the conductive member 40 or the frame 20. However, this arrangement is exemplary only, and a variety alternative arrangements may be equally suitable. For example, two separate drive mechanisms 70 may be used, one to drive each of the conductive member 40 and the frame 20. Other drive mechanisms 70 may be used to drive other configurations, both rotary and non-rotary.

Likewise, a wide variety of drive mechanisms 70 may be suitable, as noted above, including but not limited to electric motors and windmill blades. Drive mechanisms are well known, and are not described further herein.

The apparatus may include a fluid driver 80 adapted to drive fluid through the fluid path 50. As illustrated, the fluid driver 80 is a fan adapted for blowing a gas, such as air, through the fluid path 50. However, this arrangement is exemplary only, and a variety alternative arrangements may be equally suitable. Likewise, a wide variety of fluid drivers 80 may be suitable, including but not limited to pumps for driving liquid. Fluid drivers are well known, and are not described further herein.

An apparatus in accordance with the principles of the claimed invention may include more than one conductive member 40. Furthermore, any additional conductive members 40 may be disposed proximate more than one arrangement of permanent magnets 30, for example as illustrated in FIG. 3. As illustrated, the several conductive members 40 are all mounted to a single shaft 60, with fluid paths 50 proximate each conductive member 40 Also as illustrated, the frames 20 are connected with struts 90, so as to hold them fixed and rigid with respect to one another while the conductive members 40 rotate. This arrangement is exemplary only, and a variety of other arrangements may be equally suitable.

An apparatus in accordance with the principles of the claimed invention may be configured so as to produce extremely high efficiencies, in terms of the amount of heat generated compared to the energy input required. The following description is provided as an exemplary case.

In an embodiment of the claimed invention similar to that illustrated in FIG. 1, the drive mechanism 70 comprises an electric motor, supplied with 95 amperes of current at 220 volts. As is well-known, power may be calculated according to the relation:

P=I×V Equation 1:

wherein:

P is the power in watts;

I is the current in amperes; and

V is the electrical potential in volts.

In accordance with Equation 1, the power supplied to the electric motor is 20,900 watts.

In the exemplary embodiment, the fluid driver 80 comprises an electric fan, supplied with 8 amperes of power at 220 volts. According to Equation 1, the power supplied to the fan is thus 1,760 watts.

Thus, the total power input into the system is 22,660 watts. For the sake of convenience, the input power may be converted to BTU/hr. 1 watt is equivalent to approximately 3.415 BTU/hr. Thus, the total power input into the exemplary embodiment is equivalent to 77,179 BTU/hr.

Total power output in the exemplary embodiment may be conveniently determined from the change in thermal energy of fluid as it passes through the system. In the exemplary embodiment, air is used as a fluid. The heat output of the system may be determined according to the known relation:

Q=q×ρ×Cₚ×(T_{O}−T_{I}) Equation 2:

wherein:

Q is the total heat output

q is the flow rate of air through the system

ρ is the density of air

Cₚ is the heat capacity of air

T_{O} is the outlet temperature of the air

T_{I} is the inlet temperature of the air

In the exemplary embodiment, the air flowing through the device is heated by 80° F. Thus, the difference between the outlet and inlet temperatures of the air (T_{O}−T_{I}) is 80° F.

The flow rate of air through the system in the exemplary embodiment is measured to be 3200 ft³/min. This may also be expressed as 192,000 ft³/hr.

The remaining values are known to reasonable accuracy. The density of air ρ at standard temperature and pressure is known to be approximately 0.075 lbs/ft³. The heat capacity of air Cₚ is known to be 0.24 BTU/lb-° F.

Thus, according to Equation 2, the heat output of the exemplary embodiment is 276,480 BTU/hr.

The efficiency of an apparatus is commonly expressed in terms of the output divided by the input. The efficiency of the exemplary embodiment in generating heat may thus be expressed as (276,480 BTU/hr)/(77,179 BTU/hr), which reduces to a value of approximately 3.58, or 358% efficiency.

It is noted that the preceding is exemplary only. An apparatus in accordance with the principles of the claimed invention is not limited to the particular devices, materials, or power inputs and outputs described in the preceding invention.

Furthermore, 358% efficiency is in particular exemplary only, and is not to be considered to be a maximum value, a minimum value, or even a preferred value. Apparatuses in accordance with the principles of the claimed invention may be constructed with a variety of operating efficiencies.

Thus, the total heat energy generated within the conductive member 40 exceeds the total energy applied to the apparatus 10. In the case described above, the ratio of heat generated to energy applied is 3.58 to one, i.e. an efficiency of 358%.

Several comments on theoretical energy efficiency calculation may be in order at this point.

Although in the above description, as in practice, the total energy calculations are determined by measuring the heat change in the fluid (and therefore include the energy applied to drive the fluid), as a theoretical matter it might be more clear to consider the efficiency in terms of the energy applied to the conductive member 40 and/or the magnets 30 so as to produce the cyclically varying magnetic field (energy in), as compared to the heat energy produced in the conductive member 40 thereby (energy out).

For embodiments wherein the cyclical variations in the magnetic field are produced by physical motion of the conductive member 40 and/or the magnets 30, the actual input energy is kinetic in nature.

When considering kinetic energy applied, the kinetic energy applied to any supporting structures, such as a frame 20 that supports the magnets (and moves therewith) must of course be included. Thus, the kinetic energy in question is the kinetic energy applied to produce the cyclical motion between the conductive member 40 and the magnets 30, not simply the kinetic energy of the magnets 30 or the conductive member 40 alone. This is true regardless of precisely what the motion is, or of how much additional mass (if any) is moved as well.

Likewise, for embodiments wherein the cyclical variations in the magnetic field are produced by variations in the field strength of electromagnets, the actual input energy is electrical in nature.

For embodiments that use both physical motion and variable-power electromagnets, the input energy will be the sum of the applied kinetic and electrical energy.

Thus, regardless of the original source of the applied energy, i.e. whether by wind, water, an electric motor, a battery, a human or animal-operated mechanism, etc., the actual energy input for the invention for heat production is kinetic and/or electrical in nature.

Likewise, regardless of the use of the energy produced, be it the production of steam, the generation of electric power, or the deliberate heating of an object or area, the actual energy output of the invention is the heat generated within the conductive member 40.

However, it is noted that in actual applications and test conditions, it is often more convenient to measure the heat output, rather than measure the heat production directly. Likewise, it is often more convenient to measure the total energy applied to the system, rather than measure kinetic and electrical energy applied directly to the conductive member 40 and/or the magnets 30.

Such measurements may introduce small deviations into test data. For example, ancillary devices such as fluid drivers 80 consume energy, and produce some quantity of heat. The energy applied to such devices is not used directly by the magnetic heater portion of the apparatus, i.e. it does not act to vary the magnetic field experienced by the conductive member 40. Consequently, it does not generate heat in the conductive member 40. Neither the energy provided to such devices nor the heat produced by them is properly considered when calculating the efficiency of the invention.

However, in practice such deviations are of little or no consequence. First, the energy input and heat output of fluid drivers 80 and similar devices is generally very small compared to that of the heater apparatus 10 as a whole. Thus, any effect on the calculated efficiency is likewise small.

Second, because the efficiency of such known devices in transforming electricity and other energy inputs into heat is much less than 100%, this will result in test data showing efficiency that is actually lower than the true efficiency.

For these reasons, it has been considered acceptable in calculating efficiency as in the example above, wherein the total energy applied is summed and compared to the total change in heat energy of the fluid.

However, it is noted that, at least for theoretical purposes, efficiency may be properly regarded and referred to as the thermal energy produced in the conductive member 40 divided by the kinetic and electrical energy applied to the conductive member and/or the magnets in order to produce cyclical variations in the magnetic field. In its most basic terms, the heat production efficiency of the invention is its efficiency in converting this applied kinetic and electrical energy to thermal energy in the conductive member 40.

In a preferred embodiment, the heat production efficiency is at least 100%.

In a more preferred embodiment, the heat production efficiency is at least 150%.

In a still more preferred embodiment, the heat production efficiency is at least 200%.

In a yet more preferred embodiment, the heat production efficiency is at least 250%.

In an even more preferred embodiment, the heat production efficiency is at least 300%.

In a most preferred embodiment, the heat production efficiency is at least 350%.

Heat production efficiency is not necessarily limited to about 350%; higher efficiencies may be equally suitable. In addition, it may be suitable to produce heat with an efficiency of less than 100% in certain embodiments.

It is noted that efficiency at levels such as those described above, as measured during development of the invention, are unprecedented in conventional devices. It is acknowledged that levels of efficiency in excess of 100% would seem to defy conventional understandings with regard to thermodynamics. The reason for such high levels of efficiency, and the physical basis underlying them, is not fully understood at the time this application is filed. However, it is emphasized that the above efficiency calculations are based upon practical data, and are believed to accurately reflect the performance of the claimed invention.

A wide variety of possible configurations, beyond those illustrated and described in detail, are possible. Essentially any arrangement wherein a conductive member 40 is moved proximate at least one magnet 30 or vice versa may be suitable.

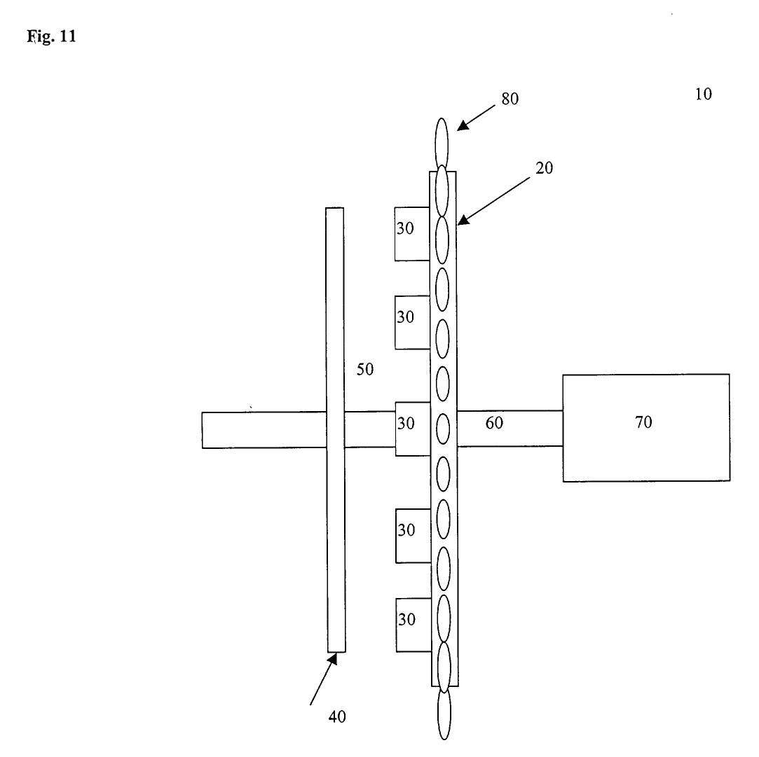

For example, for certain applications it may be advantageous to form the conductive member 40 or the frame 20 (or even the magnets 30) into a shape that drives fluid within or through the fluid path 50. For example, the conductive member 40 or the frame 20 may be configured to include vanes, blades, etc. That is, the fluid driver 80 may be integral with the conductive member 40 or the frame 20, depending on which is moving. Such an arrangement is illustrated in FIG. 11.

Furthermore, the conductive member 40 may be of essentially any shape and size. Although the precise quantity of heat produced depends in part on the geometry of the apparatus, significant amounts of heat may be produced by a device of substantially any size. At one extreme, an apparatus in accordance with the principles of the claimed invention may be made to be of microscopic or submicroscopic size. Such a device could be utilized for example in nanotechnology applications.

Conversely, an apparatus in accordance with the principles of the claimed invention may be constructed so as to be extraordinarily large, so as to be suitable for large-scale commercial or industrial applications.

The fluid flow path 50 likewise may be of various configurations. For example, one or more fluid flow paths 50 may be disposed within the conductive member 40. In one possible embodiment, a pipe might carry fluid into spaces within the conductive member 40, wherein the fluid would absorb heat from the conductive member 40.

Alternatively, fluid flow paths 50 could be connected to the conductive member 40. For example, tubing or the like could be secured to the conductive member 40, such that fluid flowing therethrough absorbs heat from the conductive member 40.

In addition, the magnets 30 themselves may have a variety of different forms. For example, a magnet 30 in the shape of a cylindrical shell may be used, with a conductive member 40 in the form of a hollow tube being rotated therein.

In addition, although the preceding discussion is directed primarily towards the generation of heat, the claimed invention may be utilized for cooling purposes as well. In such an arrangement, a fluid with a suitable boiling point and heat of vaporization, including but not limited to water or freon, would be utilized.

Fluid in the vicinity of the conducting member 40 is kept under pressure. Once the fluid absorbs heat from the conductive member 40 such that its temperature exceeds its boiling point at ambient pressure, it directed away from the conductive member 40, whereupon the pressure is released, and the fluid is allowed to expand from a liquid state into vapor. The expansion draws heat energy equal to its heat of vaporization from whatever may be in the vicinity of the expansion. The object or area thus loses that quantity of heat, and is cooled. This effect may be made to occur even when the fluid responsible for the cooling effect is warmer than the object or area that is being cooled. Thus, counter-intuitively, a hot fluid may be used for cooling.

It is also noted that heat produced by the invention, and fluids heated by the invention, may be put to a wide variety of uses. Suitable applications include, but are not limited to, as a convection furnace, as a space heater, as a cooking stove or oven, for water purification or desalinization, clothes drying, heating livestock trailers or quarters, as a hair dryer or heat gun, for humidification by evaporation, as a water heater, for air conditioning, as a swimming pool heater, for smelting or processing of ores, metals, or alloys, for food dehydration, for steam sterilization, as a Sterling engine heat source, for heat sterilization, for steam generation, for thermoelectric generation, and for the production of infrared, visible, and ultraviolet light waves via incandescent heating.

Other applications include the roasting of grains, peanuts, coffee, etc, use as a submersible heater for stock ponds, fish farms, wildlife sanctuaries, water troughs for livestock, etc, and the humidification, dehumidification, and purification of air.

It is emphasized that although many of the uses described herein are small-scale residential or commercial applications, the claimed invention is not limited to small scale applications only. The size of the device, and its heat output, may be scaled up or down as materials and space permit to fulfill a wide variety of roles. In particular, large scale agricultural and commodities processing, and industrial heating, cooling, refrigeration, and freezing may be suitable applications for certain embodiments of the claimed invention.

In addition, it is noted that an apparatus in accordance with the principles of the claimed invention may be made in a very simple fashion, without complex mechanisms and with very few moving parts.

As a result, embodiments may be constructed so as to be extremely durable, both in actual use and in terms of “shelf life”.

Furthermore, because of the relatively simple construction of the claimed invention, the limited number of moving parts, and the lack of a need for a substantial supporting infrastructure (i.e. fuel lines, waste gas venting, etc.), embodiments of an apparatus in accordance with the principles of the claimed invention may be suitable for extremely harsh or demanding environments. For example, it may be suitable for applications wherein high gee-forces and other stresses are common, such as rockets and other high-energy launch vehicles and devices, spacecraft, military vehicles, and even certain types of munitions. Likewise, it may be suitable for use in vacuum and zero-gravity or micro-gravity environments, such as in spacecraft. As a further matter, it is noted that certain embodiments may be adapted to utilize solar wind to provide rotational energy, so as to generate the cyclically varying magnetic fields.

Ultimately, the claimed invention may be useful for any application wherein heat generation, the transfer of heat from one location to another, or a product or process that may be produced or operated with heat or heat transfer (such as steam, electricity) is desired.

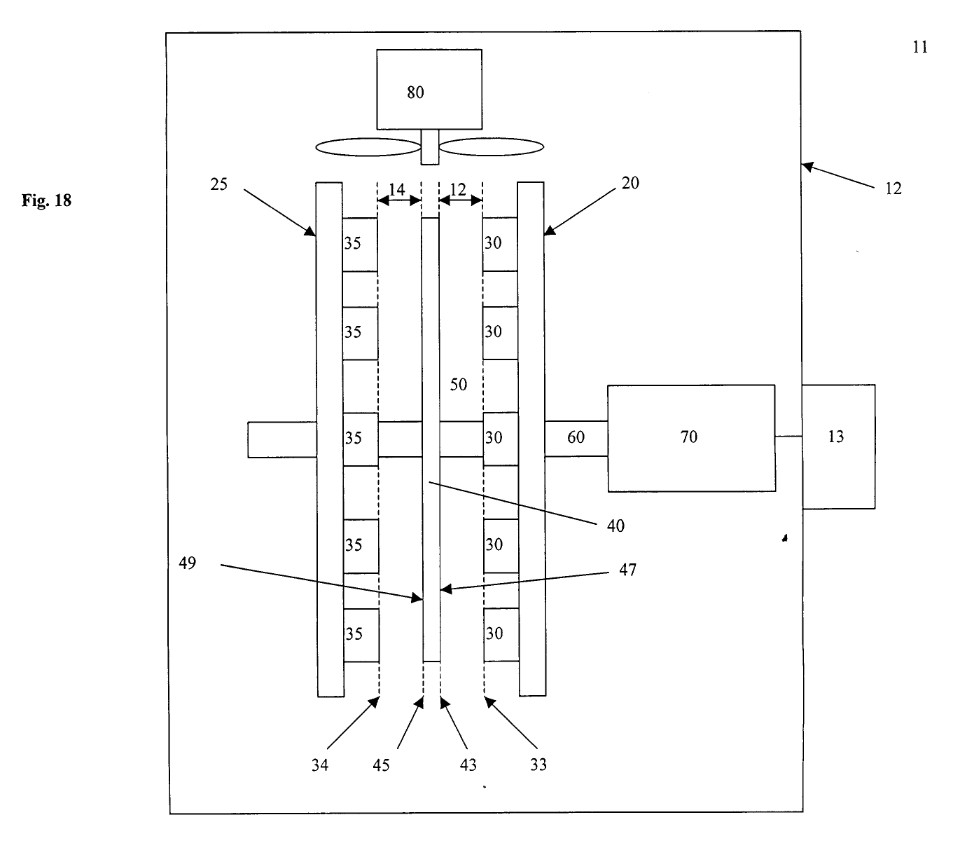

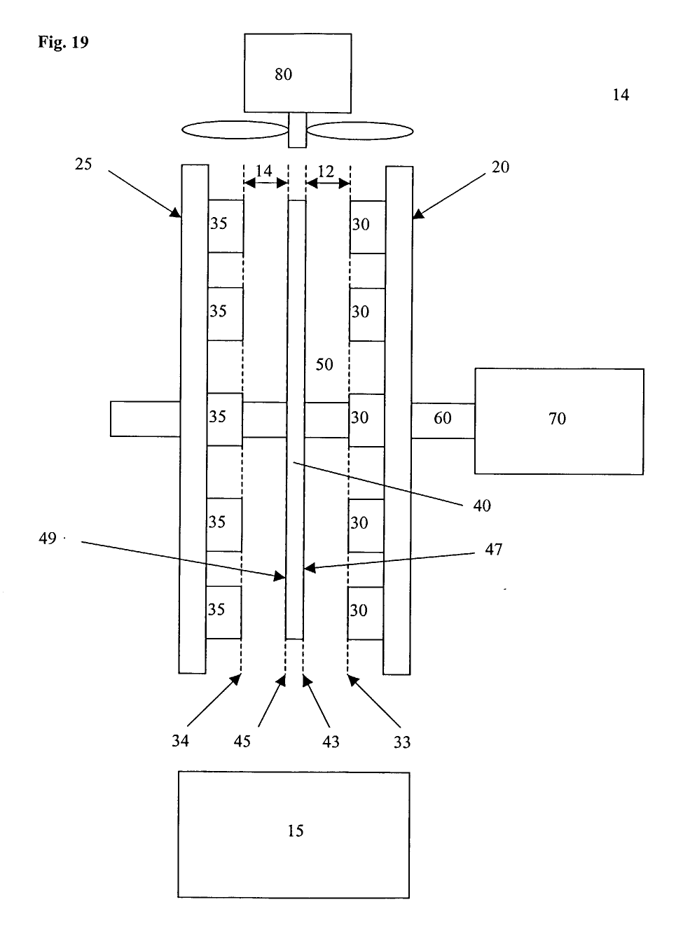

In order to more fully describe possible applications for embodiments of the claimed invention, FIGS. 18 and 19 show two exemplary devices.

The exemplary heater 11 shown in FIG. 18 includes a heater mechanism similar to that shown in FIG. 15, comprising a conductive member 40, frames 20 and 25 with magnets 30 and 35 thereon, the magnets being disposed at distances 12 and 14 from the conductive member 40. A fluid driver 80 is arranged therein to drive fluid through the fluid flow path 50. A support member 60 extends through the conductive member 40 and the frames 20 and 25, and is connected to a drive mechanism 70.

As previously noted with regard to other described embodiments, many of the components noted above and illustrated in FIG. 18 are exemplary only, and may be modified or omitted.

As illustrated, the above components are contained within a housing 12. The housing 12 provides protection for the components, and also protects persons and objects nearby from coming into contact with the hot conductive member 40, and any moving parts (such as, in certain embodiments, the magnets, frames, or conductive member).

Housings are well known, and are not described further herein.

In addition, as illustrated, the heater 11 may include a temperature control mechanism 13. The temperature control mechanism 13 provides a convenient way of controlling the heat output of the heater 11. As shown, the temperature control mechanism 13 is in communication with the drive mechanism 70. With such an arrangement, the speed of motion of moving frames 20 and 25 or conductive member 40 could be controlled thereby. However, this is exemplary only. It would also be possible, for example, to control the heat output by controlling the distances 12 and 14, or by moving the magnets 30 and 35 and/or the conductive member 40 into or out of proximity with one another.

Suitable temperature control mechanisms 13 include, but are not limited to, thermostats and fixed-level output controls (such as numbered dials or sliders). Temperature control mechanisms 13 are well known, and are not described further herein.

It is noted that, depending on the scale and the precise configuration, the heater 11 shown in FIG. 18 might be suitable for a variety of roles, ranging from a small hot air blower or space heater, to a water heater or home furnace, to a large industrial heating device.

Turning to FIG. 19, the exemplary heat driven apparatus 14 shown therein also includes a heater mechanism similar to that shown in FIG. 15. As illustrated, it comprises a conductive member 40, frames 20 and 25 with magnets 30 and 35 thereon, the magnets being disposed at distances 12 and 14 from the conductive member 40. A fluid driver 80 is arranged therein to drive fluid through the fluid flow path 50. A support member 60 extends through the conductive member 40 and the frames 20 and 25, and is connected to a drive mechanism 70. Again, many of these components are exemplary only, and may be modified or omitted.

In addition to the heater mechanism, the heat driven apparatus 14 also includes a heat operated mechanism 15. The heat operated mechanism 15 is in communication with the heater mechanism, so as to receive heat therefrom.

In FIG. 19, this is illustrated by the positioning of the heat operated mechanism 15 on the far side of the conductive member 40 from the fluid driver 80, such that the heat operated mechanism 15 would receive heated fluid therefrom. However, this is exemplary only. Other arrangements may be equally suitable, including but not limited to direct contact between the conductive member 40 and the heat operated mechanism 15, and heat transfer via direct fluid loops, secondary fluid loops, heat exchangers, radiation, etc.

The precise manner in which the heat operated mechanism 15 is in communication (i.e., the manner in which heat is provided to the heat operated mechanism 15) may vary from embodiment to embodiment, and in particular may vary depending upon the nature and function of the particular heat operated mechanism 15. So long as the heat operated mechanism 15 is in communication with the heater mechanism, and thus so long as heat is transferred to the heat operated mechanism 15, the precise manner by which this occurs is incidental.

A wide variety of heat operated mechanisms 15 may be suitable for use with the heat driven apparatus 14. Suitable heat operated mechanisms 15 include, but are not limited to, a furnace, a space heater, an electrical generator, a steam generator, an air conditioner, and a cooking mechanism. Other suitable heat operated mechanisms may include mechanisms for performing any of the applications described elsewhere herein.

Because the heat operated mechanism 15 may vary considerably, it is illustrated in FIG. 19 in schematic form only, as a “black box” device. However, in practice, the heat operated mechanism 15 may have structure, may have various outputs, and may utilize or require inputs in addition to the heat from the heater mechanism. The schematic form used to show the heat operated mechanism 15 should not be interpreted as excluding such structure, inputs, and outputs.

In particular, it is noted that although the apparatus 14 is referred to as being heat driven, this should not be interpreted as implying that other inputs or power sources are necessarily excluded. For example, in embodiments where they are present the drive mechanism 70 or fluid driver 80 may draw electrical power, or may be operated by the force of fluid flow, the turning action of a windmill, etc. The term “heat driven apparatus” as used herein refers to the fact that a source of heat is utilized by the apparatus 14 in performing its intended function, not that heat is the sole requirement or input for performing that function.

The above specification, examples and data provide a complete description of the manufacture and use of the composition of the invention. Since many embodiments of the invention can be made without departing from the spirit and scope of the invention, the invention resides in the claims hereinafter appended.

1. A heater apparatus, comprising:
at least one conductive member; and
at least one magnet disposed proximate said at least one conductive member;
wherein said at least one magnet is adapted to exert a cyclically varying magnetic field on at least a portion of said conductive member so as to heat said conductive member thereby.

2. A heater apparatus according to claim 1, wherein:
at least one of said conductive member and said magnet are cyclically movable, such that a motion of said at least one of said conductive member and said magnet causes a magnetic field exerted by said permanent magnet upon said conductive member to varies cyclically.

3. A heater apparatus according to claim 1, wherein:
said at least one magnet is an electromagnet adapted to produce said cyclically varying magnetic field.

4. A heater apparatus according to claim 1, wherein said at least one magnet is a permanent magnet.

5. A heater apparatus according to claim 1, wherein:
a quantity of heat energy generated in said conductive member exceeds a total energy applied to produce said cyclically varying magnetic field.

6. A heater apparatus according to claim 2, wherein:
said at least one conductive member rotates with respect to said at least one permanent magnet.

7. A heater apparatus according to claim 2, wherein:
said at least one magnet rotates with respect to said at least one conductive member.

8. A heater apparatus according to claim 2, wherein:
said at least one conductive member and said at least one magnet rotate with respect to one another.

9. A heater apparatus according to claim 2, wherein:
said at least one conductive member oscillates with respect to said at least one magnet.

10. A heater apparatus according to claim 2, wherein:
said at least one magnet oscillates with respect to said at least one conductive member.

11. A heater apparatus according to claim 2, wherein:
one of said at least one conductive member and said at least one magnet are affixed to a rotatable shaft, such that rotation of said shaft causes a cyclical motion of said one of said conductive member and said magnet.

12. A heater apparatus according to claim 11, wherein:
said shaft passes through another of said at least one conductive member and said at least one magnet.

13. A heater apparatus according to claim 1, further comprising:
a plurality of said magnets.

14. A heater apparatus according to claim 2, further comprising:
a plurality of said magnets.

15. A heater apparatus according to claim 14, wherein:
said magnets are disposed in a planar arrangement;
said at least one conductive member is planar in shape; and
said at least one conductive member is arranged such that a plane thereof is parallel with a plane of said planar arrangement of said magnets.

16. A heater according to claim 14, wherein:
said at least one conductive member comprises first and second sides;
said magnets are arranged proximate each of said first and second sides.

17. A heater according to claim 16, wherein:
said magnets are arranged in pairs;
a first magnet in each of said pairs is disposed on said first side of said at least one conductive member; a second magnet in each of said pairs is disposed on said second side of said at least one conductive member;
said first magnet and said second magnet of each pair are aligned with one another.

18. A heater according to claim 17, wherein:
in each of said pairs, said first magnet and said second magnet are arranged with a north pole thereof aligned in substantially the same direction.

19. A heater apparatus according to claim 14, wherein:
said magnets are arranged with alternating polarities, such that adjacent magnets have a north alignment in opposite directions.

20. A heater apparatus according to claim 19, wherein:
said polarities alternate between a north alignment directly towards said at least one conductive member and a north alignment directly away from said at least one conductive member.

21. A heater apparatus according to claim 1, wherein:
a distance between said at least one magnet and said at least one conductive member is not more than 0.35″.

22. A heater apparatus according to claim 1, wherein:
a distance between said at least one magnet and said at least one conductive member not more than 0.060″.

23. A heater apparatus according to claim 1, wherein:
said at least one conductive member comprises metal.

24. A heater apparatus according to claim 1, wherein:
said at least one conductive member comprises copper.

25. A heater apparatus according to claim 4, wherein:
said at least one permanent magnet is a rare earth magnet.

26. A heater apparatus according to claim 4, wherein:
said at least one permanent magnet is a Samarium Cobalt magnet.

27. A heater apparatus according to claim 4, wherein:
said at least one permanent magnet has an effective maximum operating temperature of at least 212° F.

28. A heater apparatus according to claim 4, wherein:
said at least one permanent magnet has an effective maximum operating temperature of at least 350° F.

29. A heater apparatus according to claim 4, further comprising:
a protective layer disposed on said at least one permanent magnet.

30. A heater apparatus according to claim 29, wherein:
said protective layer comprises aluminum.

31. A heater apparatus according to claim 1, further comprising:
a plurality of said conductive members; and
a plurality of said magnets, each of said magnets being disposed proximate said at least one of said conductive members;
wherein said magnets are adapted to exert a cyclically varying magnetic field on at least a portion of each of said conductive members so as to heat said conductive members thereby.

32. A heater apparatus according to claim 1, wherein:
the heating of said conductive member by exerting said cyclically varying magnetic field thereon produces no waste material.

33. A heater, comprising:
at least one conductive member; and
at least one magnet disposed proximate said at least one conductive member;
wherein said at least one magnet is adapted to exert a cyclically varying magnetic field on at least a portion of said conductive member so as to heat said conductive member thereby; and
a fluid path proximate said conductive member, arranged such that heat generated in said conductive member is absorbable by fluid within said fluid path.

34. A heater according to claim 33, wherein:
at least one of said conductive member and said magnet are cyclically movable, such that a motion of said at least one of said conductive member and said magnet causes a magnetic field exerted by said permanent magnet upon said conductive member to varies cyclically;
further comprising a drive mechanism in communication with and adapted to cyclically drive said at least one of said conductive member and said magnet.

35. A heater according to claim 33, wherein:
a quantity of heat energy generated in said conductive member exceeds a total energy applied to produce said cyclically varying magnetic field.

36. A heater according to claim 33, further comprising:
a fluid driver adapted to drive fluid within said fluid path.

37. A heater according to claim 36, wherein:
said fluid driver is separate from said conductive member and said permanent magnet.

38. A heater according to claim 34, further comprising:
a fluid driver adapted to drive fluid within said fluid path;
wherein said fluid driver is integral with said at least one of said conductive member and said magnet that is cyclically movable, such that a motion of said at least one of said conductive member and said permanent magnet drives fluid within said fluid path.

39. A heater according to claim 34, wherein:
said drive mechanism is adapted to be operated by at least one of the group consisting of an AC motor, a DC motor, an internal combustion engine, wind power, water power, human operation, wave action, animal power, gravity, and a rolling wheel of a transport vehicle.

40. A heater according to claim 34, wherein:
one of said at least one conductive member and said at least one magnet are affixed to a rotatable shaft, such that rotation of said shaft causes a cyclical motion of said one of said conductive member and said magnet, said shaft being in communication with said drive mechanism.

41. A heater according to claim 40, wherein:
said shaft passes through another of said at least one conductive member and said at least one magnet.

42. A heater according to claim 33, further comprising:
a housing enclosing said at least one conductive member, said at least one permanent magnet, and said fluid path.

43. A heater according to claim 33, further comprising:
a temperature control mechanism.

44. A heater apparatus according to claim 33, wherein:
the heating of said conductive member by exerting said cyclically varying magnetic field thereon produces no waste material.

45. A heat driven apparatus, comprising:
a heater mechanism, comprising:
at least one conductive member; and
at least one magnet disposed proximate said at least one conductive member;
wherein said at least one magnet is adapted to exert a cyclically varying magnetic field on at least a portion of said conductive member so as to heat said conductive member thereby; and
a heat operated mechanism in communication with said heater mechanism, so as to receive heat therefrom.

46. A heat driven apparatus according to claim 45, wherein:
said heat operated mechanism comprises at least one member of the group consisting of a furnace, a space heater, an electrical generator, a steam generator, an air conditioner, and a cooking mechanism.

47. Method of generating heat, comprising the steps of:
disposing at least one magnet proximate at least one conductive member; and
cyclically varying a magnetic field applied by said permanent magnet on at least a portion of said conductive member so as to heat said conductive member thereby.

48. Method according to claim 47, wherein:
a quantity of heat energy generated in said conductive member exceeds a total energy applied to produce said cyclically varying magnetic field.
